(19) United States
(12) Patent Application Publication
(10) Pub. No.: US 2010/0120006 A1
(43) Pub. Date: May 13, 2010

(54) Dynamic Minimally Invasive Training and Testing Environments

(75) Inventors: Audrey Bell, Acton, MA (US); Jacqueline Johanas, Brookville, NY (US); Matthew Saide, Brookville, NY (US); Caroline Cao, Brookville, NY (US); Gary G. Leisk, Boston, MA (US); Steven Schwaitzberg, Canton, MA (US)

Correspondence Address: Peter G Carroll;Medlen & Carroll, 101 Howard Street, Suite 350, San Francisco, CA, 94105, US

(73) Assignee: The Trustees of Tufts College

(21) Appl. No.: 12/310,724

(22) PCT Filed: Sep. 14, 2007
(86) PCT No.: PCT/US07/20069

§ 371 Date: Dec. 29, 2009

Related U.S. Application Data
(60) Provisional application No. 60/844,935, filed on Sep. 15, 2006.

(51) Int. Cl. G09B 23/28

(52) U.S. Cl. 434/267

(57) ABSTRACT

The disclosed invention contemplates a device and method related to training medical personnel (i.e., for example, surgeons) to perform endoscopic procedures. The disclosed technology solves two problems currently present in the art of using surgical simulators. The first improvement provides a dynamic training program, rather than a program that is the same for every training run. In one embodiment, the device provides a target array that can change position in three dimensions during the training session. In one embodiment, the target array can also change position at various velocities. Consequently, the present invention provides improved discrimination between evaluating innate skill of hand-eye coordination versus surgical skill.

### FIELD OF INVENTION

The present invention is related to training devices and methods to improve hand-eye coordination skill level. In one embodiment, a training device incorporates a moving target to improve skill level. In one embodiment, a training method improves skill levels to perform endoscopic surgery.

### BACKGROUND

Minimally invasive surgery is a growing trend in the world. This type of surgery requires more than the basic set of skills used by surgeons for regular operations. In minimally invasive surgery, the surgeon must use highly specialized tools while facing several difficult sensory challenges. Clinical medical standards provide that a surgeon must reach a high level of competence (i.e., skill level) with the use of these tools before ever attempting to execute an operation. For this reason, surgeons train and practice on minimally invasive surgical simulators that are designed to test the surgeon's skill with the tools.

Current static simulators on which surgeons are trained are not sufficiently discriminating, and do not provide an accurate means of skill assessment for laparoscopic surgeons. Depth perception and reversal of control are two of the main problems facing the surgeon. Other problems include basic hand-eye coordination, lack of a contact sensation, and friction between the tool and the port. With adequate training, a surgeon can develop an ability to correctly perform an operation.

Currently, the simulators that are used to train and test laparoscopic surgeons all contain static tasks. This has proven inadequate for two major reasons. First, the human body is not a static system. Rather, it is a dynamic system, and it is important for a laparoscopic surgeon to train working in a dynamic environment before performing a real operation. Second, these static tasks have been performed by people with varying levels of surgical experience and skill, and it was found that there was not always a correlation between the hand-eye skill level of the test subject and their performance on the task.

What is needed in the art is the ability to properly train individuals to improve hand-eye coordination in a dynamic environment and to complete a task that involves making contact with a moving object.

### SUMMARY

The present invention is related to training devices and methods to improve hand-eye coordination skill level. In one embodiment, a training device incorporates a moving target to improve skill level. In one embodiment, a training method improves skill levels to perform endoscopic surgery.

In one embodiment, the present invention contemplates a method, comprising: a) providing; i) an enclosure box comprising: I) a platform linked to at least one motor capable of moving said platform vertically and horizontally, and II) an aperture; ii) a computer program in communication with said platform, wherein said program provides movement instructions to said motor; and iii) a means of contacting said platform; and b) moving said platform at a first speed and a first direction; and introducing said contacting means through said aperture so as to make a first contact with said platform with said contacting means while said platform is in motion. In one embodiment, the method further comprises d) moving said platform at a second speed and a second direction; and e) making a second contact with said platform. In one embodiment, the enclosure box is part of a surgical simulator. In one embodiment, the platform comprises a target array and said first contact of step c) is made with said target array. In one embodiment, the contacting means comprises a surgical tool. In one embodiment, the contacting means comprises a wand or instrument.

In one embodiment, the present invention contemplates a method, comprising: a) providing; i) a first platform (e.g., a central platform) linked to at least one motor capable of moving vertically and horizontally, wherein said platform comprises a target array, wherein said platform is integrated into a surgical simulator; ii) a computer program in communication with said platform, wherein said program provides movement instructions to said motor; and iii) at least one instrument, wherein said instrument is manipulated using reversal of control; and b) moving said array at a first speed and a first direction; c) making a first contact with said array using said instrument while said array is in motion. In one embodiment, the method further comprises d) moving said platform at a second speed and a second direction; and e) making a second contact with said array using said instrument while said array is in motion. In one embodiment, the method further comprising a feedback system in communication with said computer program. In one embodiment, the feedback system provides training status information. In one embodiment, the training status information comprises training task progress information. In one embodiment, the method further comprising using said status information to determine said second speed and said second direction. In one embodiment, the array comprises a plurality of targets. In one embodiment, the status information is selected from the group consisting of the number of successful target contacts, the number of unsuccessful target contacts, the time to contact a specific target, and total training task time.

In one embodiment, the present invention contemplates a surgical training simulator, comprising: a) an apparatus comprising: i) a housing having at least one aperture; ii) at least one training instrument, wherein said instrument is inserted through said aperture; iii) a first platform (e.g., a central platform) within said housing configured for contact by said instrument; iv) a driving system comprising at least one motor linked to said platform, wherein said system moves said platform; and b) a computer program comprising a feedback system for receiving location data from said motor, wherein said motor location data controls said driving system. In one embodiment, the method further comprises a camera for capturing images of said instrument in contact with said platform within said housing while said platform is moving. In one embodiment, the housing simulates a human torso. In one embodiment, the training instrument further comprises an electrical end effector. In one embodiment, the training instrument operates by a reversal of control. In one embodiment, the driving system moves said platform in a direction selected from the group consisting of x, y, and z.

In one embodiment, the present invention contemplates a surgical training simulator, comprising: a) an apparatus comprising: i) at least one training instrument comprising an end effector electrical contact; and ii) a first platform (e.g., a central platform) comprising a target light array configured for contact by said end effector; iii) a driving system linked to said platform, wherein said system moves said platform; and b) a computer program comprising a data acquisition system for scoring said end effector contact with said array. In one embodiment, the method further comprises a camera for capturing images of said end effector in contact with said array on said platform while said platform is moving. In one embodiment, the array comprises a plurality of targets. In one embodiment, the targets are electrically connected to said data acquisition system. In one embodiment, the target light array comprises at least one illuminated target. In one embodiment, the end effector contact with the illuminated target generates a signal whereby said illuminated target is turned off. In one embodiment, the data acquisition system turns off said illuminated target when a preset task time is exceeded. In one embodiment, the end effector contact with the illuminated target generates a signal whereby a second target is illuminated. In one embodiment, the signal further provides status information to said data acquisition system. In one embodiment, the training instrument operates by a reversal of control. In one embodiment, the driving system moves said platform in a direction selected from the group consisting of x, y, and z.

In one embodiment, the present invention contemplates a surgical training simulator, comprising: a) an apparatus comprising: i) at least one training instrument comprising an end effector electrical contact; ii) a first platform (e.g., a central platform) comprising a target light array configured for contact by said end effector; iii) a driving system comprising at least one motor linked to said platform, wherein said system moves said platform; and b) a computer program comprising a data feedback system for receiving location information from said motor, wherein said motor location information controls said driving system. In one embodiment, the method further comprises a camera for capturing images of said end effector in contact with said array on said moving platform. In one embodiment, the array comprises a plurality of targets. In one embodiment, the targets are electrically connected to said data acquisition system. In one embodiment, the target light array comprises at least one illuminated target. In one embodiment, the end effector contact with the illuminated target generates a signal whereby said illuminated target is turned off. In one embodiment, the data acquisition system turns off said illuminated target when a preset task time is exceeded. In one embodiment, the end effector contact with the illuminated target generates a signal whereby a second target is illuminated. In one embodiment, the signal further provides status information to said data acquisition system to control said driving system. In one embodiment, the training instrument operates by a reversal of control. In one embodiment, the driving system moves said platform in a direction selected from the group consisting of x, y, and z.

In one embodiment, the present invention contemplates a device, comprising: a) a first platform (e.g., a central platform) having a frontal edge, a lateral edge, an underneath surface, and a top surface, wherein said top surface comprises a scissor lift; b) a second platform (e.g., a first moving platform) connected to said frontal edge; c) a third platform (e.g., a second moving platform) connected to said lateral edge; and d) a target array attached to said scissor lift. In one embodiment, the device further comprises a plurality of guiderails slidably connected to said second platform and said third platform. In one embodiment, the target array comprises a plurality of targets. In one embodiment, the targets are electrically conductive. In one embodiment, the targets are selected from the group consisting of pegs, cylinders, triangles, and nails. In one embodiment, the targets comprise a light. In one embodiment, the device is attached to an enclosure box having at least one side, wherein said guiderails are affixed to said side. In one embodiment, the device further comprises a first cantilever rod having a first and second ends, wherein said first end is connected to said enclosure box and said second end connects said second platform to said first platform. In one embodiment, the device further comprises a second cantilever rod having a first and second ends, wherein said first end is connected to said enclosure box and said second end connects said third platform to said first platform. In one embodiment, the device further comprises a first motor attached to said first moving platform and driveably engaged with said first cantilever rod. In one embodiment, the device further comprises a second motor attached to said third platform and driveably engaged with said second cantilever rod. In one embodiment, the device further comprises a third motor attached to said scissor lift.

### DEFINITIONS

The term “Dynamic Minimally Invasive Training/Testing Environment (DynaMITE)” or “training device” as used herein, refers to an integrated system for improving hand-eye coordiantion. Some training devices are compatible with a commercially available surgical simulators, while other training devices are “stand alone” units. In one embodiment, the device comprises a enclosure box of any shape or size (i.e., for example, rectangular, circular, elliptical) to which components including, but not limited to, a target array, two moving platforms, a scissor lift, and a central platform may be attached. The moving platforms are powered by independent motors that are linked to the central platform thereby resulting in the movement of the central platform in the x and y directions. The scissor lift is attached to the top surface of the central platform and results in movement of the central platform in the z direction.

The term “platform” as used herein, refers to any solid piece of material having a frontal edge, a lateral edge, an underneath surface, and a top surface that is capable of supporting a target array. A training device may comprise a plurality of platforms.

The term “central platform” as used herein, refers to any platform that is used as, or comprises a target array.

The term “moving platform” as used herein, refers to a platform that is moving. For example, a moving platform may be connected to an edge of a central platform (i.e., for example, a lateral or frontal edge). Alternatively, a moving platform may include, but not limited to, a motor and at least one cantilever rod such that the moving platform induces movement of the central platform. Further, a moving platform may comprise a target array.

The term “cantilever rod” as used herein, refers to any projecting structure that is supported at a first end and carries a load at a second end or along its length. For example, a cantilever rod may be supported by a moving platform and carry a central platform along its length, wherein the cantilever rod is driveably engaged with a moving platform.

The term “driveably engaged” as used herein, refers to the ability of a first member to induce movement of a second member. This ability may be accomplished by elements including, but not limited to, rack and pinion assemblies, gears, belts, or pulleys.

The term “guiderails” as used herein, refers to any solid piece of material that is slidably connected to either a first moving platform, or a second moving platform. Optionally, the guiderails may be affixed (i.e., for example, by adhesive or screws) to at least one side of an enclosure box.

The term “enclosure box” as used herein, refers to any form having at least one side and a floor, capable of supporting a DynaMITE training device configuration. The enclosure box is not limited to any particular shape (i.e., square, rectangular, circular, elliptical etc). Further, the enclosure box is not limited to any particular size, especially for stand-alone units. Enclosure boxes intended for use inside a surgical simulator may require tailored sized to meet compatibility requirements. For example, an enclosure box compatible with a surgical simulator may have a surface area of not more than 100 in² (i.e., for example, 10×10 inches), more preferably 80 in², but even more preferably 50 in², and approximately 8 inch sides, preferably 6 inch sides, but even more preferably 4 inch sides.

The term “scissor lift” as used herein, refers to any device capable of raising or lowering a target array. For example, a scissor lift may have a motor and at least two legs attached at their approximate midpoints such that the respective lower ends of each leg is attached to the top surface of a central platform and the respective proximal ends of each leg (attached to a target array) are capable of undergoing translation by the motor. This configuration allows the target array to rise as the proximal ends of each leg are pushed closer together, and allows the target array to lower as the proximal ends of each leg are pulled further apart.

The term “target array” as used herein, refers to any object comprising a plurality of targets capable of being attached to a top surface of a central platform.

The term “target light array” as used herein, refers to any object comprising a plurality of electrically conductive targets capable of being attached to a platform, wherein the targets are associated with a light. The light may be integrated (i.e., for example, embedded) within a target, or placed next to, and electrically connected with, a target. An embedded light may be secured in place by such means including, but not limited to, soldering, snap-in module housings or screw-in module housings. An embedded light may be secured by means including, but not limited to, molding together or snapping in place, with a cover lens wherein said cover lens is attached to the target.

The term “target” as used herein, refers to any object attached to a target array that may or may not be electrically conductive. An electrically conductive target may illuminate or transmit an electrical signal to a data acquisition system, or both, when a training instrument provides a closed circuit. For example, targets may include, but are not limited to, a nail, a peg, a cylinder, a triangle, a ring, or a simulated biological organ. Further, targets may be any size or shape within the overall design constraints as discussed herein. In these instances, a target may comprise a modular design (i.e., customizable) wherein differently sized and shaped elements may be interchanged on a target before, during, and/or after the performance of a test session. Targets may be perpendicular to the target array or at any angle. Alternatively, a target is attached to a lens comprising an embedded light. The lens may be clear, transparent, or translucent and may or may not be colored (i.e., for example, red, green, blue, yellow etc.).

The term “task target” refers to a plurality of individual targets, wherein complicated surgical tasks (i.e., for example, suturing) may be performed.

The term “surgical simulator” as used herein, refers to any commercially available device capable of visually tracking tool movement by use of a camera and monitor. Preferably, a surgical simulator emulates endoscopic surgical procedures and provides simulated instruments operated by a reversal of control (i.e., for example, a training instrument). More preferably, a surgical simulator provides sufficient internal space such that a training device contemplated herein may be inserted without compromising training instrument manipulations. For example, at least a three inch height clearance should be available after a training device is inserted into a simulator, preferably, three and one-half inches, and more preferably four inches.

The term “computer program” as used herein, refers to any mathematical algorithm capable of collecting, storing, and displaying status information generated by the training device. Further, the computer program is capable of providing commands to the training device to alter the target array speed and direction after an integrated analysis of digital electronic data and analogue video input of a training session. For example, one such computer program utilizes LabVIEW®.

The term “in communication” as used herein, refers to any electrical connection capable of transmitting either digital data signals and/or analogue video signals. For example, a target may be in communication with a data acquisition/feedback system wherein a data signal is transmitted indicating that a target was contacted by a training instrument.

The term “training instrument” as used herein, refers to any device or medical instrument and/or tool (i.e., real or simulated) manipulated by a trainee when performing a training session. For example, a training instrument may simulate an endoscopic surgical instrument (i.e., for example, a laparoscopic surgical instrument) and be operated by a reversal of control. Alternatively, a training instrument may comprise a wand or rod. Further, a training instrument may be configured with an electrical end effector for contacting targets.

The term “reversal of control” as used herein, refers to any training instrument wherein a trainee's hand movement are in the opposite direction of an end effector's movement.

The term “electrical end effector” as used herein, refers to any electrically conductive material attached to a training instrument. For example, an electrical end effector may be a contact plate attached to the distal tip of a training instrument.

The term “signal” as used herein, refers to any information transmitted to a data acquisition/feedback system from a training device. For example, when a target is contacted by a training instrument, a signal (i.e., for example, an electrical impulse) is generated and transmitted.

The term “direction” as used herein, refers to a motion vector of a central platform. For example, a direction may be in the x dimension (i.e., for example, left-to-right), the y dimension (i.e., forward-and-back), or in the z dimension (i.e., for example, up-and-down).

The term “speed” as used herein, refers to any quantitative measurement of the motion of a central platform. Speed may be determined in any direction and may be expressed as inches/second.

The term “contact” as used herein, refers to any physical interaction between a training instrument and a target such that a signal is transmitted to a data acquisition/feedback system. For example, a contact signal may include, but not be limited to, a digital data signal and/or an analogue video signal.

The term “data acquisition/feedback system” as used herein, refers to a computer database in communication with a training device that is capable of collecting signals, storing signals, analyzing signals, and providing instructions. For example, these signals may include, but are not limited to, video signals, digital data signals, and/or timer signals. Further, the instructions may include, but are not limited to, motor instructions or target sequence instructions. The system also provides notification to both the trainee and training monitor regarding training status information.

The term “status information” as used herein, refers to output data display generated by a feedback system. Status information may take the form of visual cues and/or auditory tones. For example, the trainee monitor's front panel may have a bank of colored lights (i.e., for example, red, yellow, green, or blue) to indicate whether the trainee has either passed or failed a particular testing criteria. Further, a plurality of timer displays may show whether a trainee's performance is within a preset allotted time. This information includes, but is not limited to, a status to both the trainer and trainee regarding the progress of skill improvement.

The term “successful target contact” as used herein, refers to a trainee contacting a target within an established criteria. For example, if a criteria specifies that a trainee contact Target 1 within 30 seconds, there is a successful target contact if the trainee touches Target 1 at 30 seconds or less.

The term “unsuccessful target contact” as used herein, refers to a trainee failing to contact a target within an established criteria. For example, failure may be because an allotted time limit has expired, a wrong target was contacted, targets were contacted in the wrong order, or if a proper target was missed.

The term “housing” as used herein, refers to any device into which a training device may be placed. For example, the housing may be open or completely enclosed. In one embodiment, the housing simulates a body part (i.e., for example, a human body surgical simulator) which supports the operation of a DynaMITE training device. For example, a body part housing includes, but is not limited to, a torso, a chest, an arm, or a leg.

The term “aperture” as used herein, refers to any opening within a housing that is configured to support operation of a training instrument.

The term “driving system” as used herein, refers to any configuration of motors and rods that result in the movement of a target array. Such movement may be in any direction and at variable speeds.

The term “camera” as used herein, refers to any device capable of capturing visual images and transmitting them to a feedback system. For example, a camera may be attached to the end of a training instrument. Alternatively, a camera may be operated by either the trainer or trainee during a training session.

The term “images” or “actual images” as used herein, refers to the video data collected and stored by a data acquisition/feedback system after transmission from a camera. These images are compatible with a computer program to provide analysis of the success, or failure, of a training session.

The term “attached” as used herein, refers to any permanent physical connection between two different materials. For example, permanent physical connections may include, but not limited to, adhesives, screws, or press fit insertions.

### BRIEF DESCRIPTION OF THE FIGURES

FIG. 1 presents an overall view of one embodiment of a DynaMITE training device.

FIG. 2 presents an overall view of one embodiment of a ProMIS® surgical simulator compatible with a DynaMITE training device.

FIG. 3 presents a close-up view of one embodiment of a ProMIS® surgical simulator compatible with a DynaMITE training device.

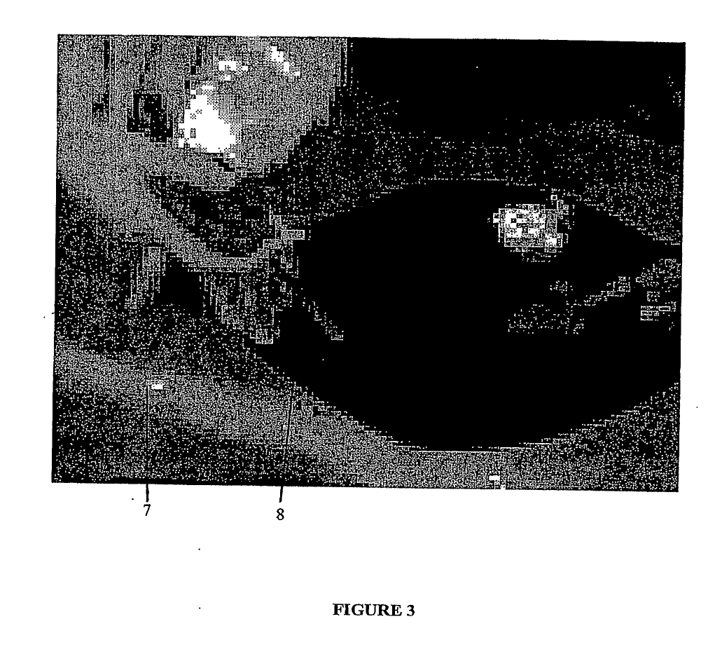

FIG. 4 presents one embodiment of a front panel of a data acquisition/feedback system computer program.

FIG. 5 presents one embodiment of a dialog box for inputting allotted training time and/or target order.

FIG. 6 presents one embodiment of a wiring diagram for LED illumination control.

FIG. 7 presents one embodiment of a wiring diagram for timer control.

FIG. 8 presents one embodiment of a timer display interface screen.

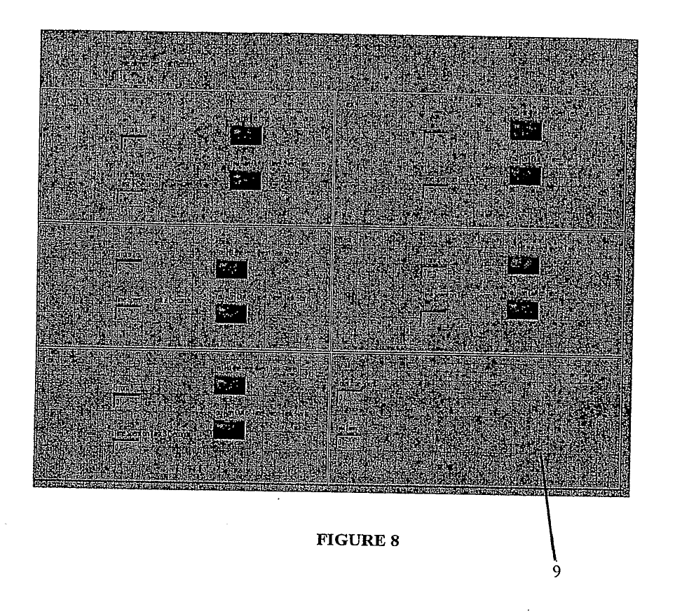

FIG. 9 presents one embodiment of a wiring diagram for signal processing.

FIG. 10 presents one embodiment of a COM control board interface setting.

FIG. 11 illustrates a STOP button as one method to properly stop target array motion.

FIG. 12 presents one embodiment of a target array “home position” (i.e., for example, coordinates (0,0)).

FIG. 13 presents a schematic of one embodiment of two cantilever driving rods 6 attached to a central platform 2.

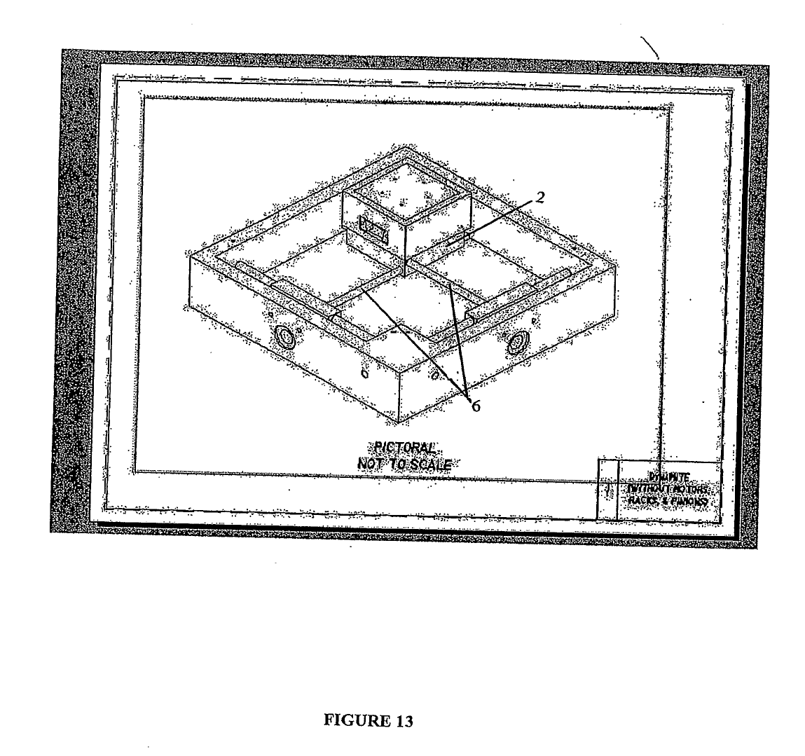

FIG. 14 presents a schematic of one embodiment of a moving platform 4 (i.e., for example, a guide block).

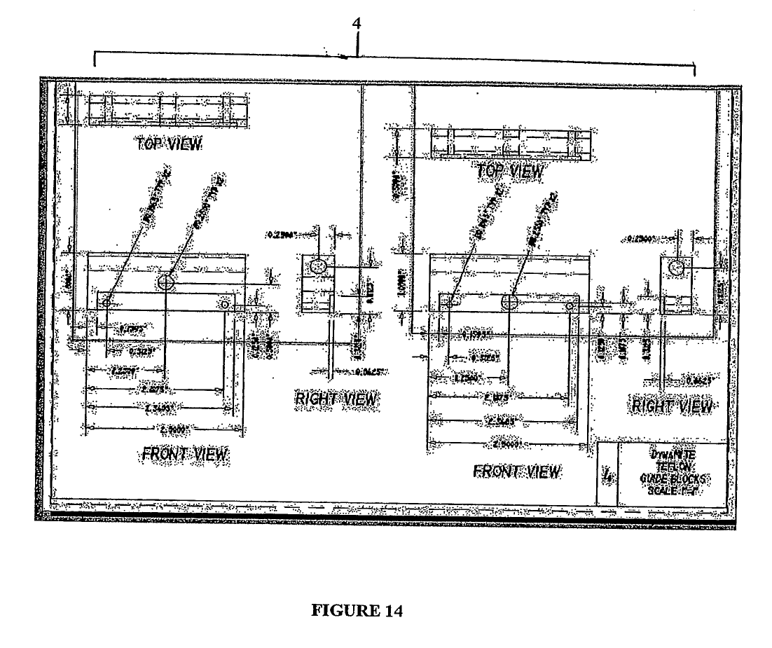

FIG. 15 presents a schematic of one embodiment of a guiderail 5.

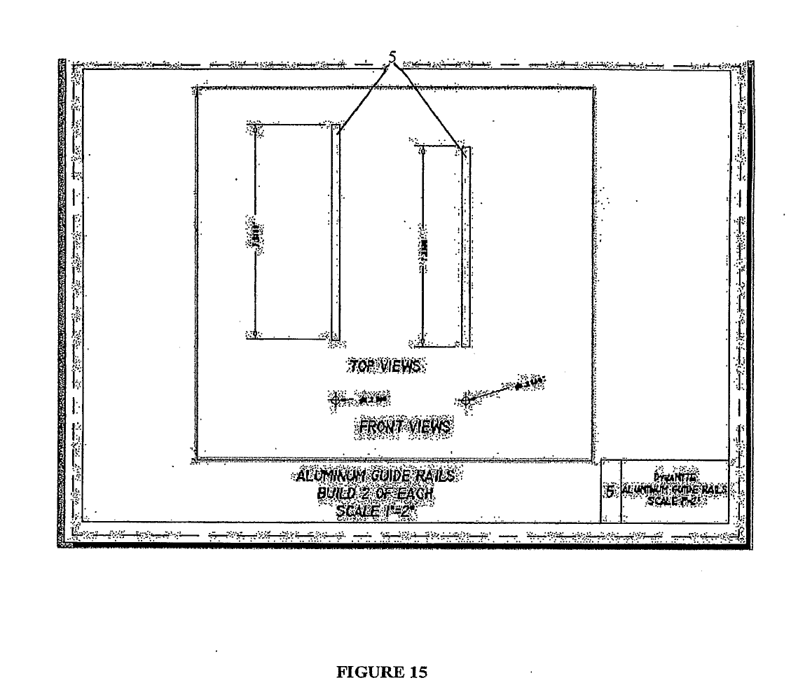

FIG. 16 presents a schematic of one embodiment of a target 14.

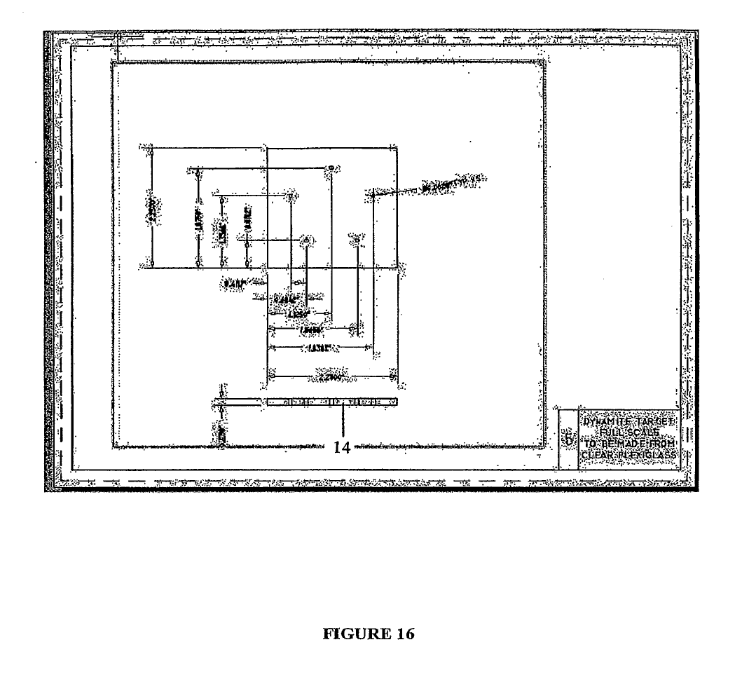

FIG. 17 presents a schematic of one embodiment of a central platform 2.

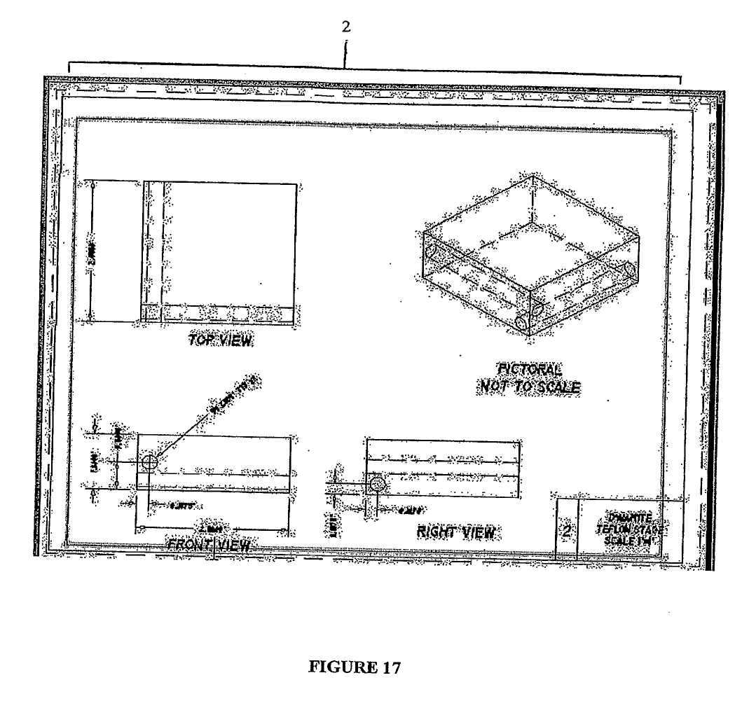

FIG. 18 presents a schematic of one embodiment of a target array 3 comprising a plurality of targets 14.

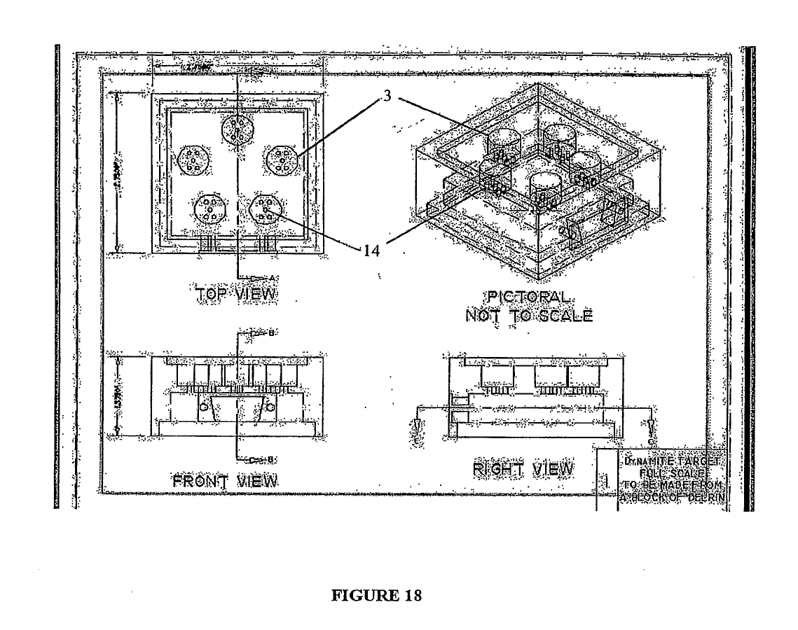

FIG. 19 presents a cross section schematic of one embodiment of a target array 3.

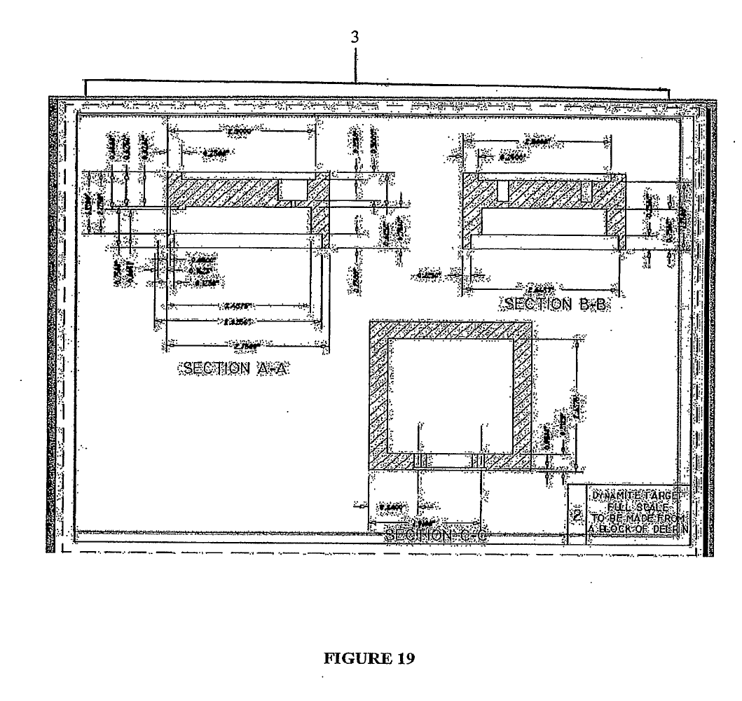

FIG. 20 presents a top view schematic of one embodiment of a target array 3 comprising a plurality of targets 14.

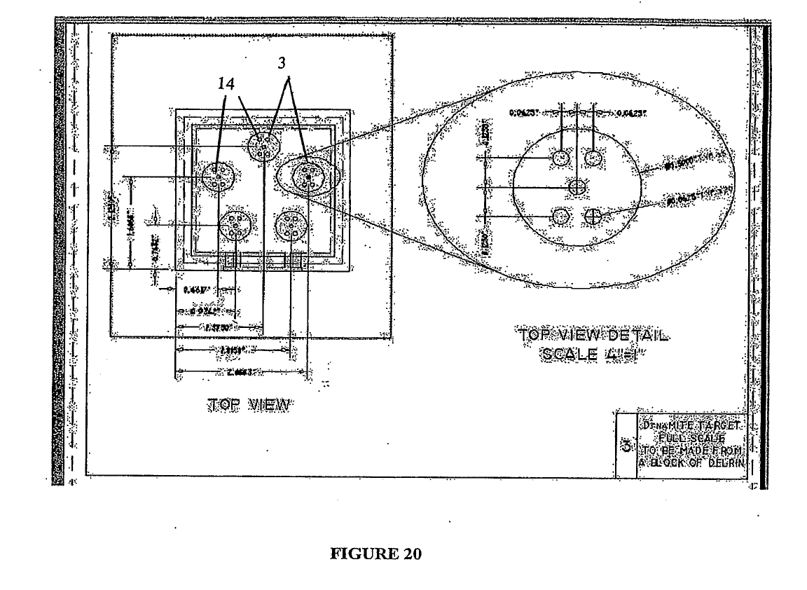

FIG. 21 presents a frontal schematic of one embodiment of a target array.

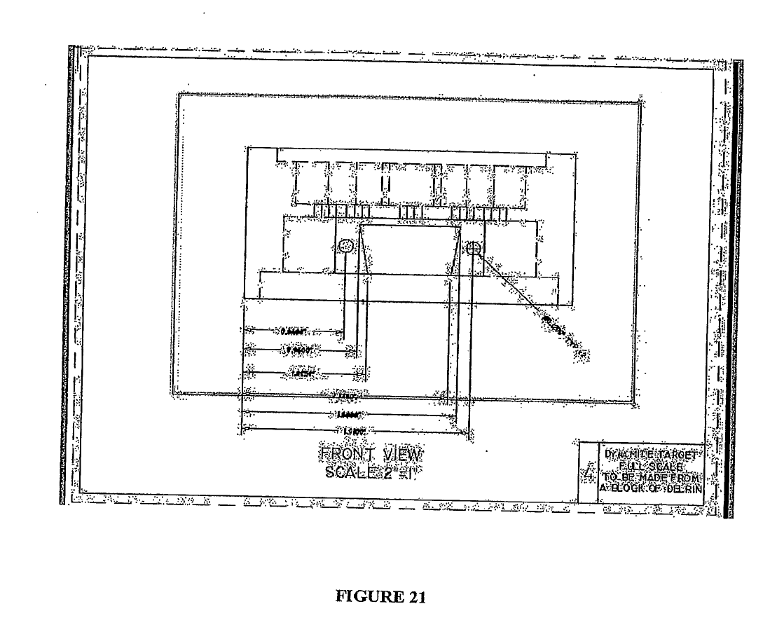

FIG. 22 presents the proper orientation of a DynaMITE training device for insertion into a surgical simulator.

FIG. 23 shows one embodiment of an NI DAQ board.

FIG. 24 presents one embodiment of a computer program connectivity setting to the motor control board.

FIG. 25 presents an overall view of one embodiment of a DynaMITE training device. In this embodiment, the targets 14 comprise embedded lights 19.

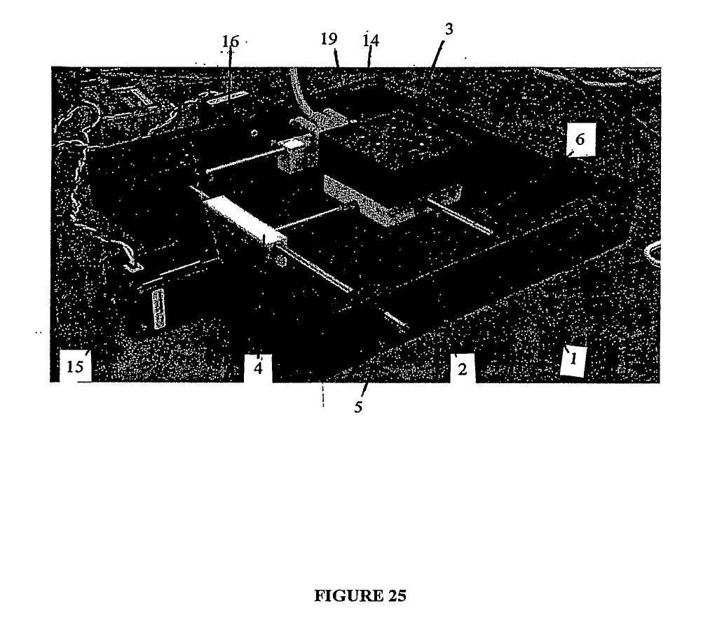

FIG. 26 presents one embodiment of a front panel of a data acquisition/feedback system computer program presenting a multipanel display of task status (upper portion); timer status (middle left portion); troubleshooting status (bottom left portion); and target path status (bottom right portion).

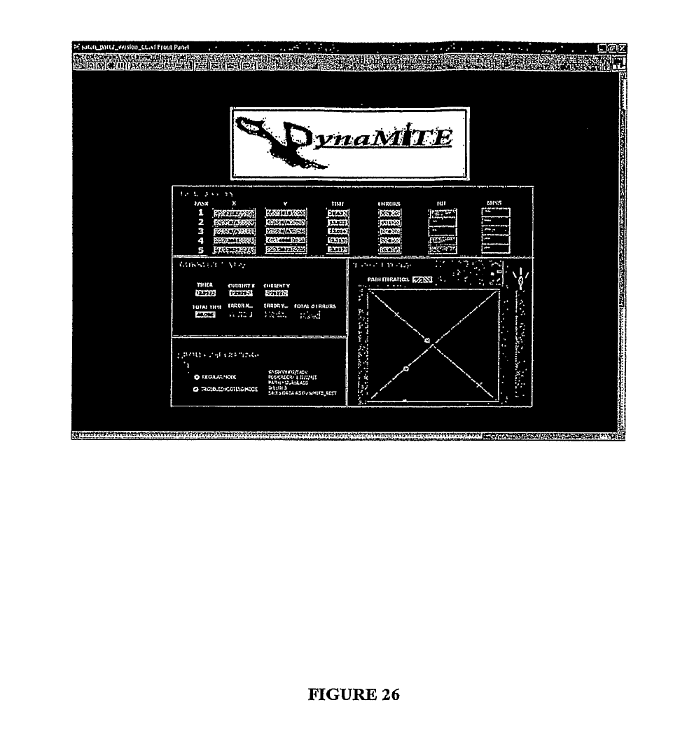

FIG. 27 presents one embodiment of a front panel of a data acquisition/feedback system computer program presenting a multipanel display of task time/order; motor speed/path; and connectivity port.

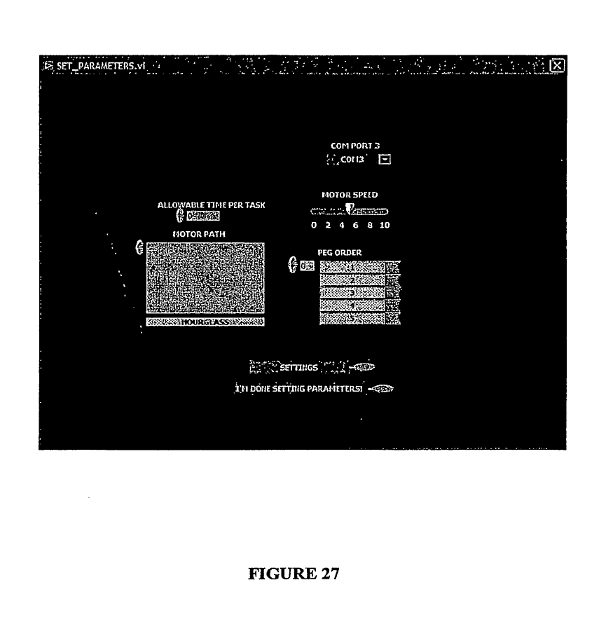

FIG. 28 presents an overall view of one embodiment of a DynaMITE training device configured with a quick-disconnect computer interface connector 20, and rack 21 and pinion 22 driving system.

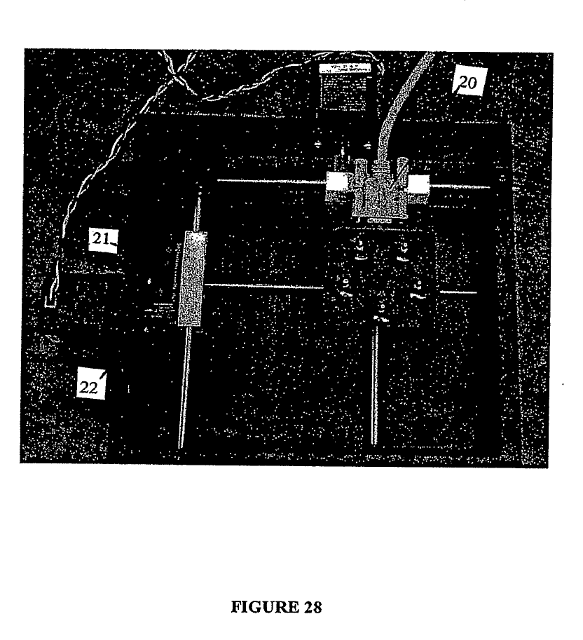

FIG. 29 illustrates a DynaMITE training box as configured for the training sessions discussed in Example V.

FIG. 30 presents exemplary data regarding the average time to task completion across experience levels during training sessions.

FIG. 31 presents exemplary data regarding the total misses across experience levels during training sessions.

FIG. 32 presents exemplary data regarding the total errors across experience levels during training sessions.

### DETAILED DESCRIPTION

The present invention is related to training devices and methods to improve hand-eye coordination skill level. In one embodiment, a training device incorporates a moving target to improve skill level. In one embodiment, a training method improves skill levels to perform endoscopic and/or laparoscopic surgery.

In one embodiment, the present invention contemplates a Dynamic Minimally Invasive Training/Testing Environment (DynaMITE) training device comprising a target array to provide training for minimally invasive surgery (i.e., for example, laparoscopic surgery). In one embodiment, the array undergoes motion. In one embodiment, the training device is compatible with an existing surgery simulator (i.e., for example, ProMIS®). In one embodiment, the training device increases the level of difficulty by providing variable speeds of the target array in the x, y, and z directions. In another embodiment, the training device comprises a feedback system which identifies and records task success. In one embodiment, task success comprises completion time. In another embodiment, task success comprises the number of errors made.

### I. Laparoscopic Surgery

Laparoscopic surgery is characterized by small incisions in the body through which a camera is inserted and surgical tools are manipulated, less trauma, reduced scarring, and shorter hospitalization time, making it a preferred procedure over open abdominal surgery. Nguyen et al. “Laparoscopic Versus Open Gastric Bypass: A Randomized Study of Outcomes, Quality of Life, and Costs” Annals of Surgery. 2001; 234(3): 279-291. However, laparoscopic surgery can be susceptible to a great deal of error due to sensory challenges that are not present under the conditions of conventional open surgery. A recent comparison of laparoscopic versus open hernia repair reported that 22 out of 469 (4.7%) laparoscopically treated patients were readmitted after surgery, compared to 10 out of 415 (2.4%) patients treated with open surgery. Earle et al., “Laparoscopic versus open incisional hernia repair” Surg Endosc. 2006; 20: 71-75. Injury to the bile ducts during cholecystectomy occurs at a rate of 0.41%-1.1%³, compared to 0%-0.4% in open surgery. Denzeil et al., “Complications of laparoscopic cholecystectomy: a national survey of 4,292 hospitals and an analysis of 77,604 cases” Am J Surg. 1993; 165: 9-14. This is approximately three times higher than in open surgery. Archer et al., “Bile duct injury during laparoscopic cholecystectomy: results of a national survey” Ann Surg. 2001; 234: 549-559; Strasber et al., “An analysis of the problem of biliary injury during laparoscopic cholecystectomy” J Am Coll Surg. 1995; 180: 101-125; and Traverso L W, “Risk factors for intraoperative injury during cholecystectomy: An ounce of prevention is worth a pound of cure” Ann Surg. 1999; 229: 458-459. Therefore, a conservative estimate of 500,000 annual laparoscopic surgeries means that there are 2000 bile duct injuries per year. Hugh T B, “New strategies to prevent laparoscopic bile duct injury—Surgeons can learn from pilots” Surgery 2002; 132: 826-835. Other research suggests that injury rates have not improved with time or experience. Adamsen et al., “Bile duct injury during laparoscopic cholecystectomy: A prospective nationwide series” J Am Coll Surg. 1997; 184: 571-578. A recent study, suggests that the misidentification of biliary anatomy stems principally from misperception, not errors of skill, knowledge, or judgment. Way et al., “Causes and prevention of laparoscopic bile duct injuries—Analysis of 252 cases from a human factors and cognitive psychology perspective” Ann Surg. 2003; 237: 460-469.

One of the most prominent problems encountered when performing laparoscopy is the lack of depth perception in the laparoscopic environment. Nicolaou et al., “Invisible shadow for navigation and planning in minimal invasive surgery” Med Image Comput Comput Assist Intery Int Conf Med Image Comput Comput Assist Interv. 2005; 8(Pt 2):25-32. During surgery, the bright light used to illuminate the body cavity creates a workspace with few shadows. This, combined with the translation of the 3D work environment to a 2D image, creates a visual scene from which depth cues cannot be easily perceived. Hanna et al., “Shadow depth cues and endoscopic performance” Arch Surg. 2002; October; 137(10):1166-9. The consequences of not being able to accurately judge an object's proximity from the camera include performance inefficiency and potential damage of surrounding tissue from misjudgment of distance.

Recent laparoscopic surgical training has demonstrated that surgical simulators can be used to improve the skill of laparoscopic surgeons prior to operating on a person. Andreatta et al. “Laparoscopic skills are improved with LapMentor training: results of a randomized, double-blinded study” Ann Surg. 2006; June; 243(6):854-60. However, existing physical simulators contain only static, or stationary, target objects. While some of the tasks in these simulators require trainees to manipulate or pick up a needle or suture from different locations within the surgical environment (depending on where the needle or suture was dropped or placed), the target object is rarely in active dynamic motion during the acquisition phase. This may be a limitation of current simulators in that they do not provide an adequately challenging environment for the acquisition of advance hand-eye coordination skills in laparoscopic surgery, such as manipulating dynamically moving tissues. For example, surgeons go to great lengths to immobilize target tissues during surgery because of the extreme difficulty of performing fine manual tasks on a moving target, and the lack of training in such maneuvers. The resulting disadvantages that the surgeon faces, and the consequences a patient can suffer as a result of inadequate training, suggest a need for a training environment that can provide exposure and experience with a wide range of task difficulty, including tracking dynamically moving targets. Since the surgeon is sometimes required to operate with rhythmic body motion in the patient (e.g., beating heart or respiratory motion), a training program that develops advanced instrument positioning skills is highly desirable.

Past attempts at training surgeons to accurately gauge depth have called for the relocation and manipulation of objects at various distances in a static environment, as well as the cutting and suturing of static, or non-moving, objects. Peters et al., “Development and validation of a comprehensive program of education and assessment of the basic fundamentals of laparoscopic surgery” Surgery 2004; 135(1): 21-27. In these simulators, the trainee provides all of the motion; the target objects remain stationary even while they are being manipulated and moved around in the surgical environment. This method of training results in skills that are only moderately representative of those required in the dynamic environment of the human body.

The present invention contemplates a device and method that uses a mechanically-controlled dynamic targeting system to supplement the laparoscopic training environments with objects that can actively move in any selected direction relative to the camera. Although it is not necessary to understand the mechanism of an invention, it is believed that training enhancements are expected to improve a surgeon's ability to efficiently control his or her tool motion, differentiate between an object in the foreground and background of the video image, and target specific objects while leaving the surrounding environment unharmed. In one embodiment, the present invention contemplates a prototype system and a method of training to solve the above discussed problems.

### II. Minimally Invasive Surgery Training

While performing minimally invasive surgery (i.e., for example, laparascopic surgery), a surgeon cannot see inside the body of the patient. This problem has been solved by attaching a camera to an endoscopic instrument for insertion inside a patient, thereby allowing a surgeon to see inside of the patient via a video monitor. This type of video display is problematic because the display is a two dimensional image of a three dimensional reality, thereby making accurate depth perception a serious problem. A) surgeon must rely on training to properly interpret the two dimensional image correctly and avoid harming the patient.

Generally, endoscopic medical instruments are mounted on what is essentially a long instrument attached to a specific medical tool and inserted into a patient's body. Due to the distance of the medical tool from the surgeon, the surgeon is not able to directly manipulate the tool. Rather, a surgeon must indirectly control the tool from a distance. As an additional complication, in order for the tool to move in one direction, a surgeon's hand moves in the opposite direction. This reversal of control can be disorienting to a surgeon, thereby necessitating extensive training.

A comparative study between a virtual reality endoscopy training unit and a mechanically based endoscopy training unit using conventional video included either viewing or contacting a static target array. This target array consisted of a variety of shapes and sizes, usually elongated pipe-like structures. Some of the target array structures were positioned at an angle, while others were positioned perpendicularly. These training devices and methods did not provide for contacting a target array with an instrument with a target array in motion. Lehmann et al., “A Prospective Randomized Study To Test The Transfer Of Basic Psychomotor Skills From Virtual Reality To Physical Reality In A Comparable Training Setting” Annals Of Surgery 241:442-449 (2005).

Some endoscopic training apparati allow that a target may be moved to any desired position before a training session begins. For example, the positioning of the target is maintained using either clamps or suspended from a chain. The target, however, does not move during the actual training exercise. McKeown, M., “Apparatus For Practicing Surgical Procedures” U.S. Pat. No. 5,149,270.

A laparoscopic training device has been reported that simulates the dynamic motions of a live patient by simulating motions representative of respiratory (i.e., inspiration/expiration), circulatory (i.e., pulse, heart beat), digestive (i.e., peristalsis), and general involuntary bodily movements that are known to occur during actual surgical procedures. The training device introduces these motions using a series of tubes through which liquids and/or gases are passed in or near the target organs of the training exercise. The training method, however, uses static arrays within the training device. Stolanovici et al., “Device And Method For Medical Training And Evaluation” United States Patent Application Publication No. 2005/0214727 (herein incorporated by reference).

Another endoscopy training device is reported to have an instrument manipulated by a user that provides input into a simulation program running on a computer. The instrument interfaces with a capture member that is capable of horizontal movement and/or arcuate movement in order to simulated various endoscopic pathways. Guide passageways are configured such that frictional forces may be placed upon the capture member to simulate turns and/or obstructions. The training method, however, uses static targets within the training device. Cunningham et al., “Surgical Simulation Interface Device And Method” United States Patent Application Publication. No. 2001/0016804.

### II. Methods of Using a Hand-Eye Coordination DynaMITE Training Device

In one embodiment, the present invention contemplates a method providing an improved discriminating hand-eye coordination training device. In one embodiment, the training device simulates laparoscopic surgery. In one embodiment, hand-eye coordination is improved over conventional simulators by moving a target array in the x, y and z directions. Although it is not necessary to understand the mechanism of an invention, it is believed that this ensures that the trainee's performance is dependent on skill level alone, and not luck. It is further believed that skill level may be improved by varying target speed, path shape, and target pattern complexity.

In another embodiment, improved skill level and performance is determined using a feedback system. In one embodiment, the feedback comprises trainee task completion time (i.e., for example, duration in seconds, minutes and/or hours). In one embodiment, the task comprises contacting a target on the target array. In another embodiment, the feedback comprises trainee errors. In one embodiment, an error comprises contacting an incorrect target. In another embodiment, an error comprises contacting targets in the incorrect order. In another embodiment, an error comprises repeatedly contacting the same target. In another embodiment, an error comprises missing an intended target. In another embodiment, an error comprises not contacting an intended target within an allotted time. It is intended that this feedback system is compatible with the current abilities of any currently available surgical simulator (i.e., for example, ProMIS®) such that the tool path and path smoothness may be tracked.

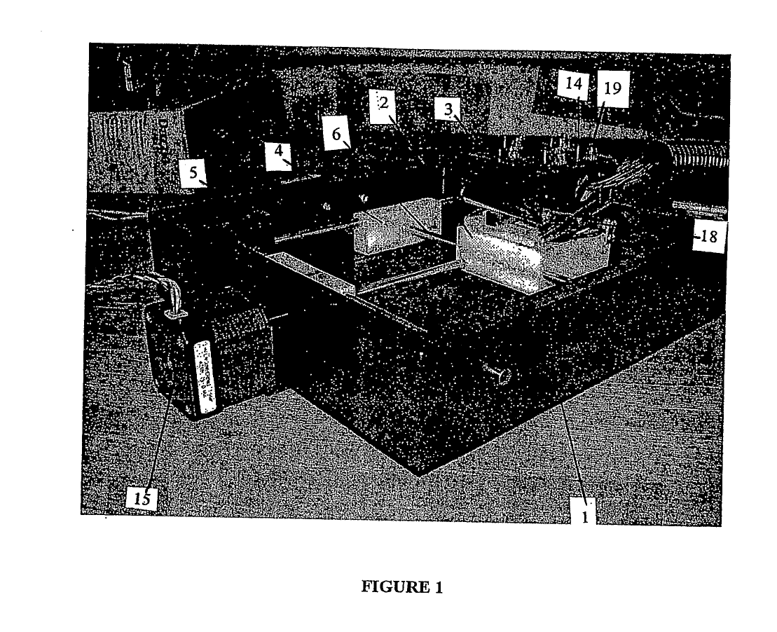

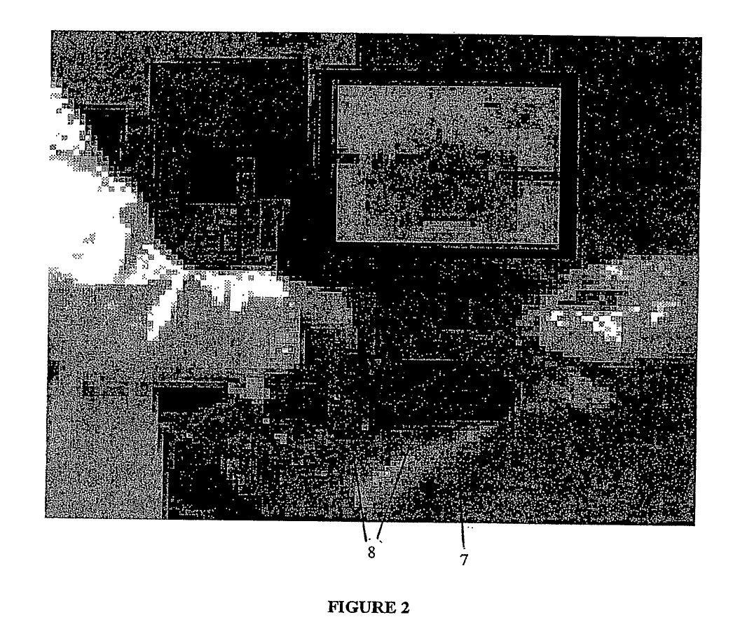

For example, a training device contemplated by the present invention comprises a data acquisition/feedback system, a target array capable of multidirectional movement. In one embodiment, a training device comprises an enclosure box 1 containing a central platform 2 that supports a scissor lift 18 and a target array 3 comprising a plurality of targets 14 with associated lights 19, wherein the central platform 2 is connected to a moving platform 4 mounted on guiderail 5 and attached to cantilever rod 6 powered by a motor 15. See FIG. 1. In one embodiment, a training device is compatible to fit inside an existing surgical simulator (i.e., for example, ProMIS®). In one embodiment, the simulator comprises a housing 7 and at least one training instrument 8. See, FIGS. 2 & 3. In one embodiment, the dimensions of a training device contemplated by the present invention is less than 10 inches long by 10 inches wide and provides an approximate three inch height clearance with the simulator when in operation.

In one embodiment, the present invention contemplates a method comprising training a first individual and a second individual. In one embodiment, a first individual undergoes hand-eye coordination training and a second individual undergoes monitoring training. In one embodiment, the second individual monitors light emitting diode (LED) signals that provide feedback information regarding the task status of the first individual's hand-eye coordination training. Although it is not necessary to understand the mechanism of an invention, it is believed that this system eliminates distractions such as having to memorize the order in which to contact the targets, or distracting noises that would be present if the system used audio feedback. It is further believed that ease of use for the second individual is provided with a computer program comprising intuitive menus and dialogue boxes to input specific test parameters and automatic results upon the completion of the task.

### III. Training Device Development

Initial attempts to fabricate embodiments of the present invention were unsuccessful.

One such unsuccessful design had a two dimensional linear stage with a cam driven z axis. At first, height constraints were not a consideration. Further, the only dimensional constraints were limited to a 14×14 inch box that could house the training device. An iterative decision-making process identified the most effective way to get the x-y motion by mounting one linear stage atop a second one at a 90 degree angle. The x-y motion was then considered to be driven by powerscrews with motors attached to the ends.

A desired travel of 12 inches was an initial criteria which required the complete linear stage length (including the motor) to be about 24 inches long. This, however, exceeded the box dimensional constraints (i.e., for example, 14 inches). Consequently, another design iteration lead to a smaller range of motion. Not only did the smaller travel distance decrease the overall size of the training device, it also improved the overall design because the view of the moving task could be projected on a screen and there would be a distinct range that the moving task could actually cover.

Regarding the z motion, a cam driven platform was originally considered due to its simplicity and effectiveness. This design called for a stage to be mounted on four columns that would not only provide stability but would also act as guiderails for the platform to slide up and down on. Since height was not considered a constraint, additional space was created under a stage for the cam and motor. A metal cam (i.e., for example, aluminum) to generate a one inch vertical displacement finally designed. This design, however, ultimately failed because it was too bulky and heavy.

A design concept was then considered that introduced specifications that would be compatible with a commercially available surgical simulator (i.e., for example, a ProMIS® surgical simulator). One advantage of using a commercially available surgical simulator is that tool movement tracking is already incorporated into the device. This approach makes height constraints relevant to the overall design. For example, in order for enough room to be left in a simulator for tool manipulation, the training device can operate in the z dimension (i.e., for example, up-and-down) where an approximate 3 inch clearance remains between the training device and the simulator.

This consideration resulted in the abandonment of the unsuccessful design (supra) wherein height was not a consideration. Two dimensional linear stages having the desired travel and a height constraints were not commercially available. Consequently, an empirical process generated various embodiments contemplated by the present invention where a training device comprises the proper linear travel range paired with the proper height constraints. Through much iteration in the design process, DynaMITE training device was conceived. In one embodiment, the training device design comprises two cantilever rods controlled by two separate moving platforms to push and pull a central platform comprising a target array, wherein the target array is moved vertically using a scissor lift.

A. Physical Constraints

In one embodiment, the present invention contemplates a training device compatible with a commercially available surgical simulator (i.e., for example, ProMIS®). In one embodiment, the training device is easily installed and removed. Although it is not necessary to understand the mechanism of an invention, it is believed that compatibility and easy installation and removal will not result in damage to the surgical simulator. In one embodiment, the training device comprises a maximum length and width of 10 inches by 10 inches.

In one embodiment, the present invention contemplates a training device wherein the maximum height is less than eight (8) inches. In another embodiment, the training device comprises a maximum height of approximately four (4) inches. Although it is not necessary to understand the mechanism of an invention, it is believed that a height less than eight inches allows a training device to fit inside a surgical simulator and allows clearance for training instrument manipulation. For example, this configuration will allow training instruments held at a minimum of a 30 degree angle, thereby clearing the surgical simulator ceiling by approximately three (3) to four (4) inches.

In one embodiment, the present invention contemplates a training device wherein a target array is configured to move in three directions: x, y, and z. In one embodiment, the total range of z motion is approximately one inch. In one embodiment, the total range of x motion is approximately two inches. In one embodiment, the total range of y motion is approximately two inches.

B. Program Constraints

In order to provide improvements over currently available training tasks, the training tasks contemplated by the present invention comprises variability; that is, a variety of tests can be performed without altering the physical set-up. In one embodiment, the training monitor can vary the difficulty of the test, depending on the trainee's skill level.

In one embodiment, test variety comprises target array motion that is capable of being tracked such that the target array location is known at any given time. Although it is not necessary to understand the mechanism of an invention, it is believed that a data acquisition/feedback system assures the training monitor that the stage is properly following the selected path.

In one embodiment, a data acquisition/feedback mechanism comprises LED's to indicate test status information (i.e., for example, trainee success or failure). In another embodiment, a data acquisition/feedback system allows a training monitor to input any desired order for contacting the targets, wherein the input causes signal emission from the selected targets detectable by a trainee.

In one embodiment, a data acquisition/feedback system is capable of tracking progress, errors, success and/or failure. For example, a tracking data comprises proper target contacts, improper target contacts, target misses, and other errors (i.e., for example, exceeding a preset allotted time or incorrect target order). Although it is not necessary to understand the mechanism of an invention, it is believed that these tracking data is sufficient to allow the training monitor to determine the trainee's progress and/or determine the trainee's skill level by evaluating a success rate/failure rate weighted by a task complexity factor.

### PREFERRED EMBODIMENTS OF THE PRESENT INVENTION

The following detailed description is not intended to be limiting and is only intended to describe one embodiment of the training device contemplated by the present invention.

### I. Primary Elements

A. Z Motion

In order to achieve a vertical displacement of approximately one inch while conserving height at the lowest point, a scissor lift was designed to provide the z motion. At its lowest height from the bottom of the target array, the scissor lift stands two inches high. This was achieved by making the members of the scissor lift as thin as possible without compromising the integrity of the design. One pair of the legs of the scissor lift was set in a sixteenth of an inch on both sides so that the scissor lift could lower to a shorter height and the legs wouldn't interfere with each other. The scissor lift also provides a large amount of vertical displacement for relatively little horizontal displacement of the legs. In one embodiment, in order for the target array to move up one inch, the legs are pulled together approximately 0.21 inches.

Driving the scissor lift is a rack and pinion assembly with a pinion head mounted directly onto a 78.4 mN-m Parallax stepper motor shaft which is press fit into, and flush with, a central platform. This motor will run forward and reverse to push and pull the rack engaged with the pinion head. The rack is attached to a spacer in between two of the legs of the scissor lift which not only distributes the pulling force between the members of the lift, but also keeps the rack in the correct position to be engaged with the pinion head at all times. This configuration provides direct pushing and pulling action with no members interfering with the force transfer from the rack to the legs of the lift. In one embodiment, the racks and pinion gears comprise a module of 0.5 and are made from brass.

B. X and Y Motion

X and Y movement of a central platform is accomplished by two sets of rack and pinion drive assemblies independently attached to an x moving platform and a y moving platform, respectively. Each rack and pinion assembly has a 55 oz-in High Torque Stepper motor controlling a pinion that is press fit directly onto the shaft. This pinion head engages a rack on the back of the stage and pushes and pulls the stage back and forth in its respective direction. In one embodiment, the racks and pinion gears comprise a module of 0.5 and are made from brass.

C. Motors

Two different types of motors were used to create one embodiment of a DynaMITE training device. The first was the 78.4 mN-M Parallax stepper motor which drives the scissor lift thereby providing z motion. This motor was chosen due to its size and torque. A small lightweight motor was needed to fit into the platform because minimizing the amount of weight added to the central platform reduces the torque requirements for the x and y moving platform motors. The Parallax stepper motor was lightweight and provided the proper amount of torque for z translational motion of the central platform. The Parallax stepper motor is connected to an independent power source and control board.

Two NEMA 17 High Torque Motors, operating at 0.45 amps each (Lin Engineering) control translation of the x moving platform and y moving platform, respectively. These motors were chosen based on their size, amps drawn, torque, light weight and were extremely quiet. These motors supply a 55 oz-in torque which is greater than the design requirement of approximately 20 oz-in of torque necessary to induce translation of the central platform. However, this design enhancement provides an advantage of smooth operational control and response. Further, these motors are 1.85 inches long, thereby meeting the size constraints for maximizing the x & y travel within a surgical simulator. A single Parallax control board (maximum 1.0 amp capacity) was used to operate both NEMA motors. This design has the advantage of saving considerable space.

### II. Materials

In various embodiments of the present invention materials and parts can be obtained using off-the-shelf sources. See Table 1.

TABLE I
Exemplary Off-The-Shelf Materials & Parts

| Part Name | Part Number | Vendor | Quantity | | Price |
|---|---|---|---|---|---|
| .5M Brass Pinion | A1B9MY05018 | Stock Drive | 1 | meter | $34.88 |
| Wire | | Products | | | |
| .5M Brass Rack | A1B12MYKW05200 | Stock Drive | 1 (200 mm) | | $34.19 |
| | | Products | | | |
| NEMA Size 17 | 4218L-25 | Lin | 2 | | $68.00 ea. |
| High Torque | | Engineering | | | |
| Stepper Motor | | | | | |
| 303 Stainless | 88915K45 | McMaster- | 1 (.25″ | | $14.71 |
| Steel Precision | | Carr | diameter × | | |
| Ground Rod | | | 6′ length | | |
| Black Delrin | 8575K631 | McMaster- | 1 (2″ × 12″ × | | $157.08 |
| Sheet | | Carr | 12″) | | |
| Virgin PTFE | 32019440 | MSC | 1 (4″ × 12″ × | | $275.91 |
| | | | 1″) | | |
| M3 Screws | — | Tags | 10 | | $2.00 |
| | | Hardware | | | |
| 16 × 1″ Wire Nails | — | Tags | 1 | oz. | $1.50 |
| | | Hardware | | | |

| | | | | |
|---|---|---|---|---|
| 12 V Unipolar | M42SP-5 | Parallax | 1 | $12.00 |
| Stepping Motor | | | | |
| LEDs | — | Radioshack | 50 | $65.00 |
| NI DAQ Board | NI DAQ 6008 | National | 1 | $150.00 |
| | | Instruments | | |
| Motor Control | 30004 | Parallax | 2 | $99.00 ea. |
| Board | | | | |

A. Teflon®

In various embodiments, many of the components of a DynaMITE training device are made from Teflon®, in part because it is easy to machine and is self-lubricating. The central platform comprises Teflon® to facilitate movement of the guiderails through the platform itself during movement in the x and y directions. Teflon® may also be considered as an alternate material for bushings or sleeve bearings because of its self-lubricating properties. The top plate of the scissor lift comprises Teflon® to allow sliding of the two free legs of the scissor lift thereby avoiding the use of slide bearings or roller joints.

Teflon® was also used to protect target array wiring and LED's due to its superior insulating property. The two moving platforms that control the x and y movement were made out of Teflon® as well. These moving platforms, while sliding back and forth in their respective directions, are stabilized by guiderails. Once again, Teflon® use avoided integrating sleeve bearings into the design. Even though the cantilever rods extending from these moving platforms are press fit together, the soft nature of Teflon® did not result in moving platform/cantilever rod dislocation.

B. Delrin®

The enclosure box of the DynaMITE training was made from Delrin®. This plastic was chosen for its machinability property as well as its hardness and color (i.e., for example, a reddish-brown). A Delrin® enclosure box construction facilitates simulator set-up by minimizing errors and handling damage. Guiderail and moving platform configurations are maintained within close tolerances and the hardness of Delrin® prevents unintended movement due to twisting and/or sudden impacts. Consequently, a Delrin® enclosure box helps to ensure that every moving part is maintained in the correct place and at the correct angle during integration and deintegration procedures. For example, all guiderails were mounted at a 90 degree angle from each other which required precise alignment or else the platform moving along one of the rails would jam up on the apposing rail. A smooth surface obtained from the Delrin® composition provides an ideal sliding surface for the Teflon® platforms. Further, the Delrin® enclosure box keeps all DynaMITE training device components together as one compact machine as well as providing very clean aesthetics.

C. Stainless Steel

All the guiderails used in the DynaMITE training device were made from stainless steel. Stainless steel has certain advantages over other metals (i.e., for example, aluminum, brass, etc.) including, but not limited to, strength, stiffness, or finish. One quarter inch diameter precision ground undersized rods were used for each guiderail. The smaller diameter allowed for the design of the parts that the rails were penetrating to be of a smaller size and ultimately the whole apparatus to be smaller. Even though there was a potential that the guiderails could possibly deflect under the pressure of the moving platform, the strength of the stainless steel along with a minimal guiderail length (i.e., for example, approximately 7 to 7.5 inches) prevented any deflection. The precision ground finish made for very smooth sliding over the Teflon®. The slightly undersized rods also allowed for a firm press fit into the insertion holes within the moving platforms.

D. Aluminum

Scissor lift legs and brackets (i.e., for example, providing attachment points for some Teflon® parts) are all made from aluminum. Aluminum is stiff enough that even when using only one sixteenth of an inch, the small pieces do not deflect. Aluminum is also readily available in various thicknesses and easy to machine. The legs and brackets contained clearance holes for 6-32 screws to allow for rotation and attachment to the top of the central platform and bottom plate of the scissor lift.

### III. Data Acquisition/Feedback System

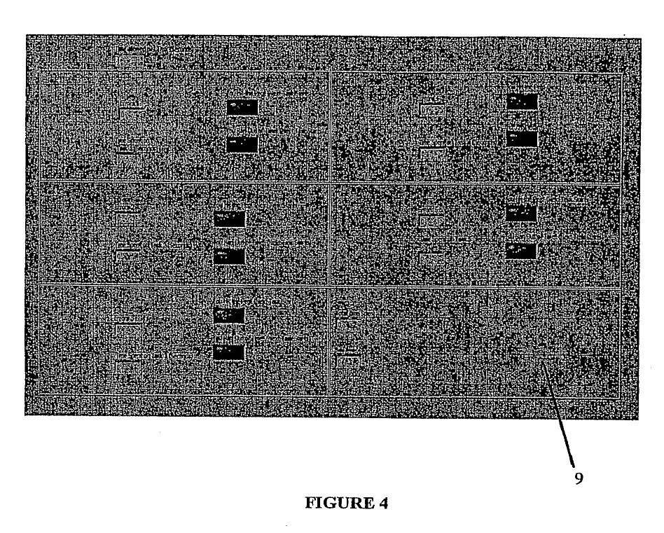

The data acquisition/feedback system for some DynaMITE training device embodiments was accomplished using a LabVIEW® program. This program provides training status information using various capabilities including, but not limited to, timing the completion of the task, controlling LED's, and counting the number of user errors made. Training status information is updated as the program runs (i.e., for example, real-time information) and this real-time information is viewed by a training monitor using a front panel display 9. See, FIG. 4.

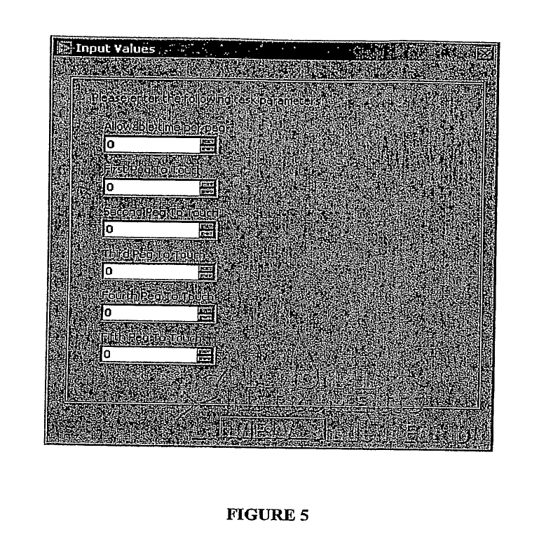

At the outset of a training session, the training monitor enters test criteria using a dialog box for criteria parameters including, but not limited to, target allotted time, total test allotted time, or target contact order. See, FIG. 5. For example, any number of targets may be selected, in any order and targets may be repeated, if desired.

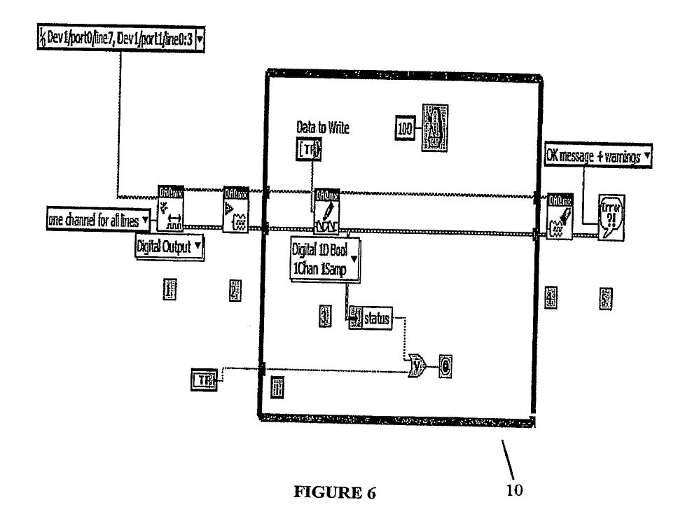

A data acquisition/feedback system contemplated by the present invention provides a front panel display of training status information. In one embodiment, this front panel display is configured so that the training monitor and/or trainee does not need to look away from the training video output to view the status information. Although it is not necessary to understand the mechanism of an invention, it is believed that this configuration minimizes confusion and errors made due to reasons other than a lack of skill with surgical tools. In one embodiment, the front panel display comprises LED's that light up to inform the training monitor/trainee of status information including, but not limited to, which target to contact, whether a successful contact has been made, or whether the time allotted for the training task has expired. It is not intended to limit this invention to a single feedback system, but one compatible software that achieves these requirements is a LabVIEW® program in conjunction with a National Instruments DAQ board. In one embodiment, this system communicates a digital signal to a desired LED at a desired training time, wherein the signal indicates to the trainee that a particular target requires contacting. One embodiment of an LED illumination circuit diagram 10 for this aspect of the DynaMITE training device is illustrated. See, FIG. 6.

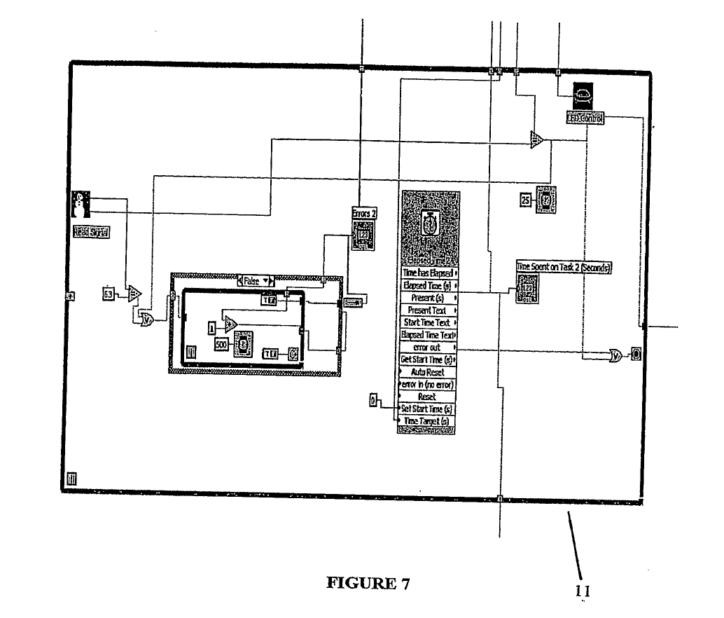

A DynaMITE training device comprises various timing capabilities. In one embodiment, a timer measures how long it takes the trainee to make contact with each target. In another embodiment, a timer measures how long it takes the trainee to complete the overall training task. In another embodiment, a timer measures an allotted task duration time (i.e., for example, preset by the training monitor), and notifies the trainee when the allotted time has expired. For example, notification of the expiration of allotted time may use an indicator including, but not limited to, LED lights on the target (i.e., notifying the trainee) or a light on the front panel display (i.e., notifying the training monitor). Representative timer control wiring diagram 11 and associated front panel display 9 are illustrated. See, FIGS. 7 & 8, respectively.

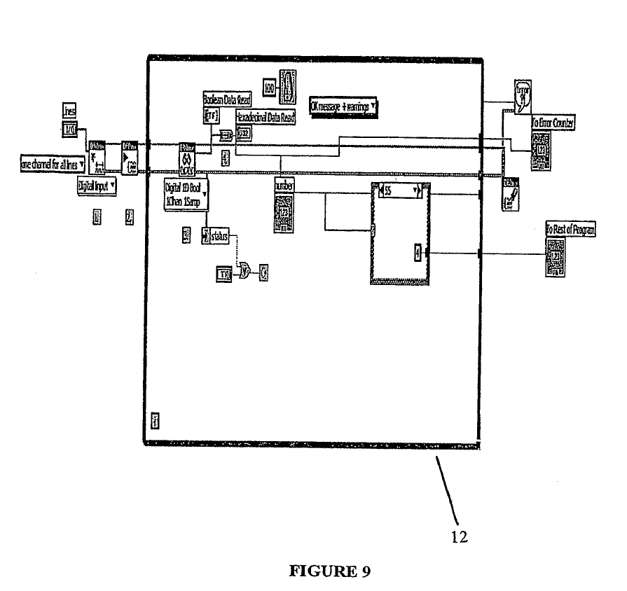

In one embodiment, a target comprises a conductive metal. In another embodiment, the conductive metal is wired to an individual terminal of the NI DAQ board. Although it is not necessary to understand the mechanism of an invention, it is believed that the target array is also a conductive metal object and connected to the ground terminal of the board, whereby when the trainee makes contact between the circuit and the board, a circuit is closed that can be detected by the data acquisition/feedback system (i.e., for example, by utilizing a LabVIEW® program). A representative signal processing wiring circuit 12 is illustrated. See, FIG. 9. Once a task has been completed, the feedback system presents the trainee with a dialogue box that summarizes the results. For example, this status information includes, but is not limited to, the amount of time taken to contact each target, how many times an incorrect nail was contacted, or how many targets were missed.

### IV. Motion Control

Each x and y motor was tested first in Hyperterminal® (standard diagnostic software on most PC-compatible computers) to ensure that it properly communicates with its respective serial port, and then programmed using the data acquisition/feedback system software (i.e., for example, LabVIEW® 7.1). In one embodiment, a DynaMITE training device interfaces with at least two serial ports and one USB port. If a computer does not possess a USB port, a serial-to-USB converter cable is a viable alternative.

For proper Hyperterminal® communication with the control board, the following settings are recommended: 9600 Baud Rate, 8 data bits, no parity, 1 stop bit, and flow control off. Emulation was adjusted to TTY and under ASCII Setup, and the “echo type characters locally” was turned on. This option instructs Hyperterminal® to display the output commands.

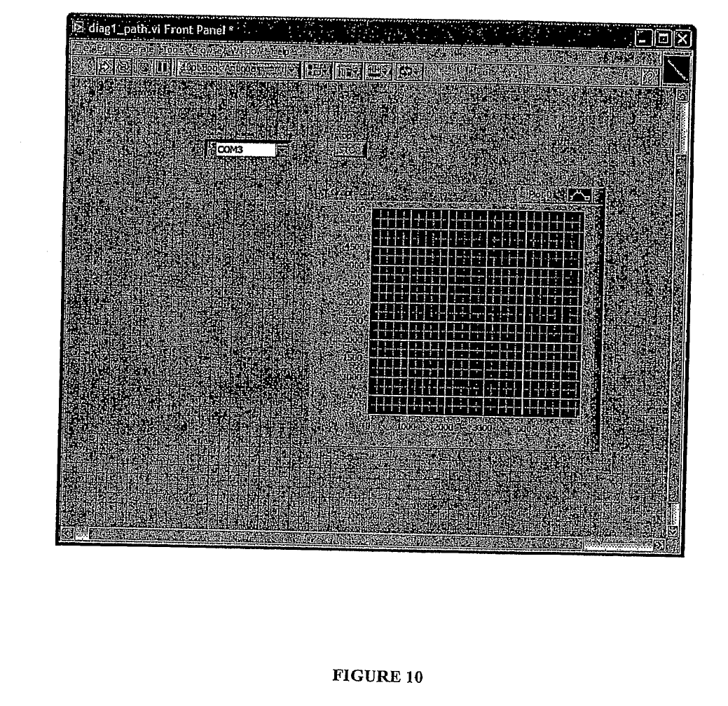

In LabVIEW®, the “Serial Communication Example VI” was altered to make the above settings as default and the read option was deleted. A COM port is then selected that notifies the computer program of the control board's serial port address. See, FIG. 10.

In order to provide feedback to the user, the read portion of the “Serial Communication Example VI” was used, this time with the write portion deleted. The settings were also changed to the above, default values.

Resetting the motor control board can be performed by simply unplugging/replugging the board or by activating a Reset Command (i.e., for example, 4!). The Reset Command resets other settings as follows (equivalent commands noted in parenthesis):
Sets the Automatic Full Step rate to be 3072 microsteps/second (3072A)
Selects both motors for the following actions (B)
Resets both motors to be at location 0 (0=)
Sets both motors to full power mode (0H)
Sets the “Stop OK” rate to 80 microsteps/second (80K)
Sets the motor windings Order to “microstep” (3O)
Sets the rate of changing the motor speed (essentially the acceleration) to 8000 microsteps/second/second (8000P)
Sets the target run rate to 800 microsteps/second (800R)
Enables all limit switch detection (0T)
Sets transmission delay to zero (1V)
Sets full power to motor windings (0W)

The 4! Command is issued at the start of every “motor path subVI” routine. This ensures that every “motor path subVI” starts at the same settings, so that different “motor path subVI” routines may be created by changing only a few settings. In one embodiment, a fully programmed “motor path subVI” routine includes, but is not limited to, Diag1, Diag2, or Hourglass1. In one embodiment, Diag1 moves a central stage between the coordinates (0,0) and (5500,5500). In one embodiment, Diag2 quickly moves a central stage to (5500,0) and then oscillates between that (5500,0) and (0,5500). In one embodiment, when a test is ended, the central platform returns to (0,0). In one embodiment, Hourglass1 comprises a combination of Diag1 and Diag2, thereby moving in an hourglass pattern. Although it is not necessary to understand the mechanism of an invention, it is believed that every path starts and ends at (0,0), thereby acting as a safeguard such that a training monitor can choose any “motor path subVI” and not have to consider whether a previous test left the central platform in an unknown position.

Since each “motor path subVI” routine comprises more than one command transmitted to a control board, a traffic control method was designed. For example, if a control board receives a command such as “X1000G”, the x motor makes 1000 microsteps. However, if the control board receives another command, such as “X0G” while it was in the process of executing the “X1000G” command, the “X1000G” command is aborted and the “X0G” command is executed.

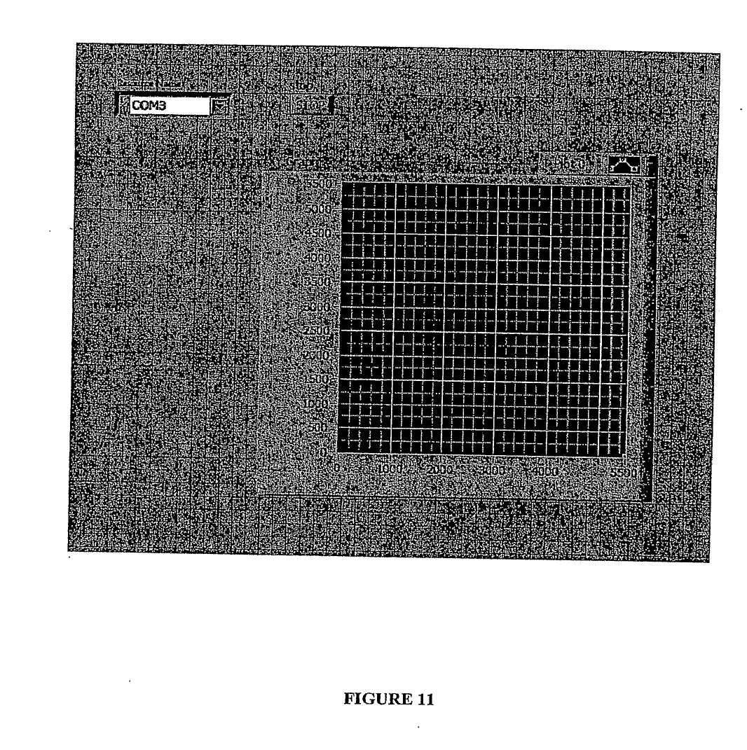

This problem was solved by using a “Read subVI” subroutine. This allowed for a “motor path subVI” routing to determine where the exact location of the central platform. When the central platform reaches its destination, as read by the “Read subVI” routine, the control board provides the next instruction command to the “motor path subVI” routine. Integrating this process into a “While Loop”, the x, y, and z motors are capable of controlling central platform movements without time constraints. Configuring a STOP button into the “motor path subVI” routine allows a training monitor and/or trainee to end central platform movement when the test is complete. See, FIG. 11. For example, the x, y and z motors complete execution of the current loop iteration, and then receive instructions to return to coordinates (0,0). When the central platform reaches the origin, the “motor path subVI” routine ends.

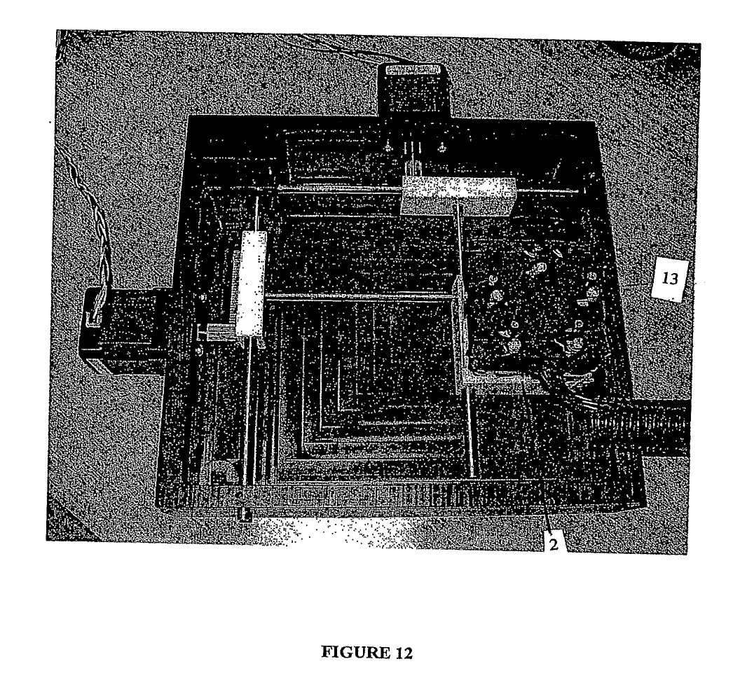

Before a new training session begins a central platform 2 location verification is performed. The training monitor and/or trainee visually inspects the central platform 2 to ensure that it is at coordinate location (0,0). If the central platform 2 is not at the origin, it may be manually returned to coordinates (0,0). This correct “home” origin position 13 of the central platform 2 is illustrated. See, FIG. 12.

In order to provide feedback to the training monitor and/or trainee an XY graph that charts the motion of the stage using the X and Y motors is configured on the front panel display. By using the “Read subVI” routines real-time central platform coordinates are analyzed and plotted. This real-time graph allows a training monitor and/or trainee to see the path traced out by the central platform. Although it is not necessary to understand the mechanism of an invention, it is believed that a point and line option may be used to display the path, wherein every point represents the point at which the sample of data was taken by the “Read subVI” routine.

### V. Training Scenarios

Although it is not necessary to understand the mechanism of an invention, it was believed that that hand-eye coordination skills would be harder to control in a dynamic environment than a static one. Training sessions performed in the DynaMITE simulator has partially support this theory. See, Example V. For example, subjects having a preexisting high level of training (i.e., for example, experts) had significantly better smoothness values in the static task than in any of the moving conditions. However, post-hoc Tukey tests revealed no significant performance differences in time to completion when static targets were compared to slowly moving targets. Since the static task was always performed first, the users may have gained familiarity with the testing environment during the static test that proved useful to improving scores on the later dynamic tests. Alternatively, it is also possible that the slow speed chosen for this experiment was in fact too slow, and too similar to a static test.

It was also believed that a faster and more complex path would prove to be harder. Again, the results from training sessions only partially supported by the data, as the novice group did not show this effect. This observation may be explained by the fact that subjects with a low level of previous training (i.e., for example, novices) had no experience at all, and therefore found all surgical tasks equally challenging. Subjects with a high level of training (i.e., for example, experts) on the other hand, were well-practiced in the static and slower tasks. Experts also showed performance, deterioration only with the fast and unpredictable target movements.

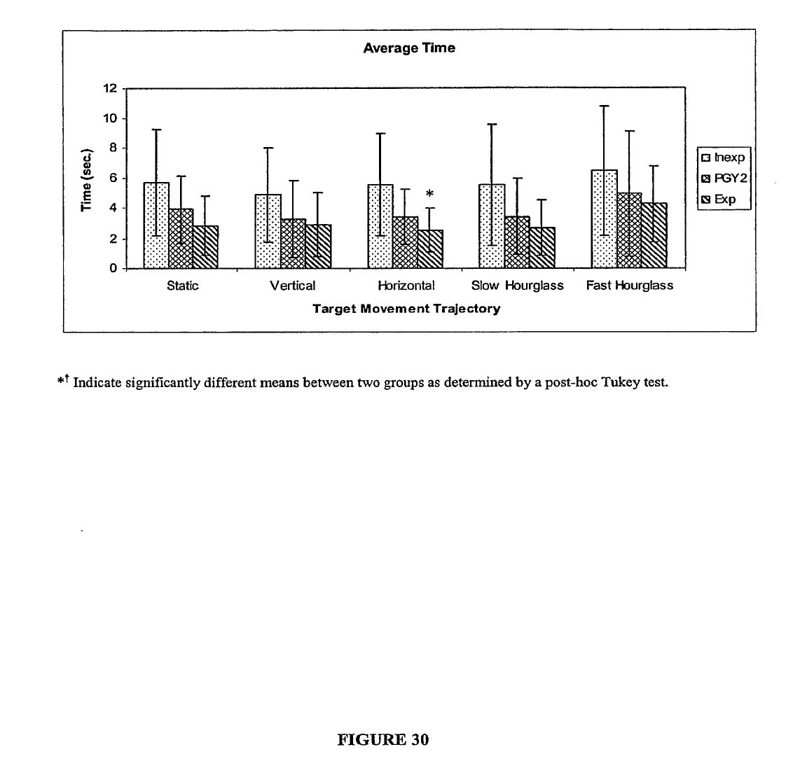

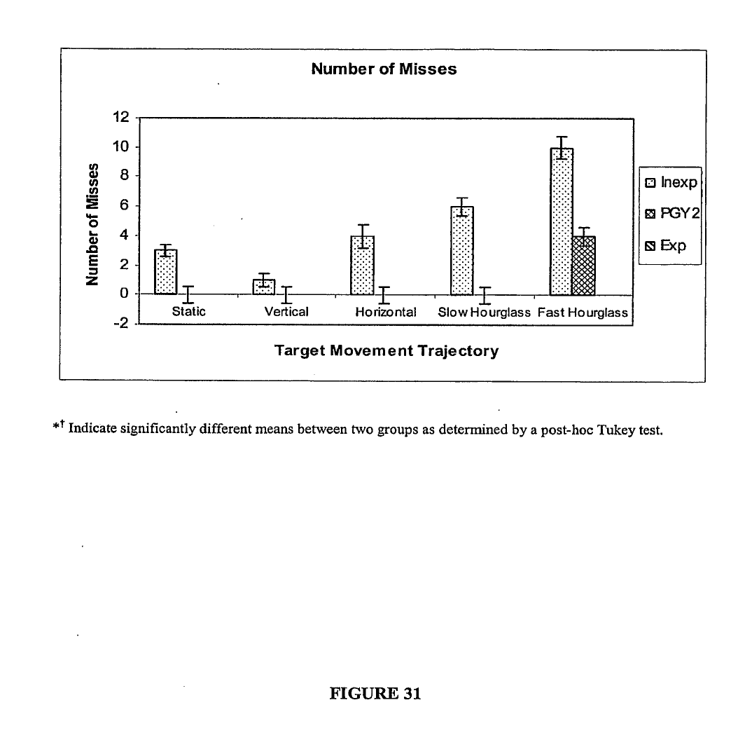

It was also believed that the range of data would decrease as the subjects' training level increased. Surprisingly, the novices performed equally slowly for all of the conditions (see, FIG. 30), but made progressively more misses in the vertical, slow hourglass and fast hourglass conditions, with the highest'number of misses in the fast hourglass condition. (see, FIG. 31). The data suggests that there may be a speed-accuracy tradeoff, i.e., wherein accuracy is sacrificed for speed. The experienced surgeons, on the other hand, were slower in the fast hourglass condition, but made no misses, sacrificing speed for accuracy. (see FIG. 31). Although it is not necessary to understand the mechanism of an invention, it is believed that this can be attributed partly to the surgeons' previous experience in surgery, and on previous models of static training simulators which gave them additional familiarity with the task unavailable to the novices.

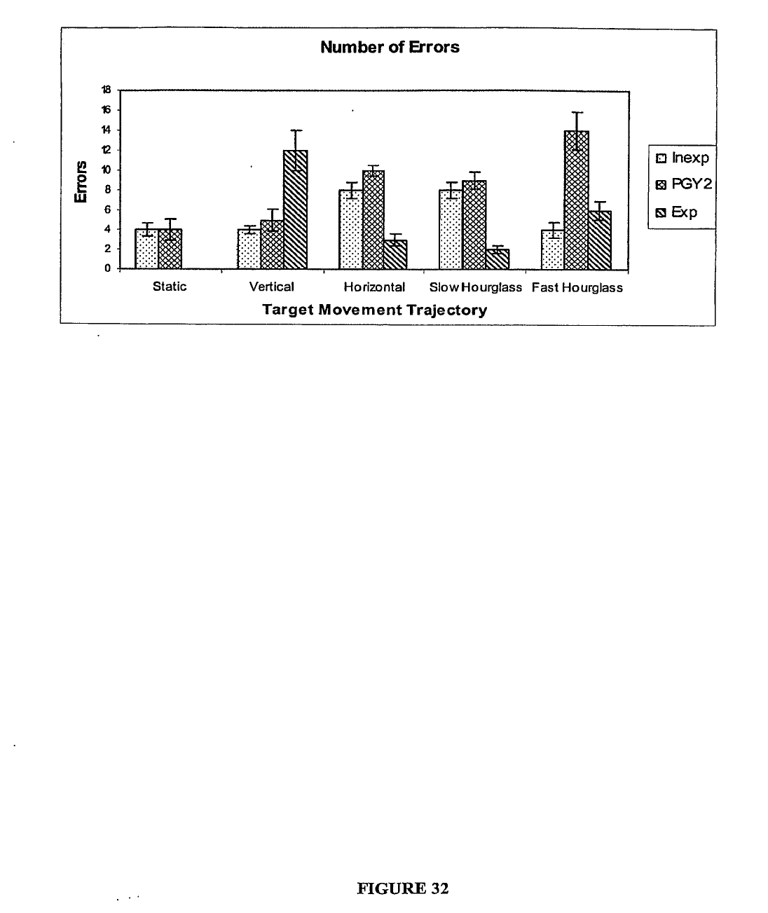

Although the error data do not show clear trends according to subject experience, level of training, or dynamic task conditions, the number of errors made was lower in the static condition than in any of the dynamic conditions for both experts and PGY2s. (see FIG. 32). Notable for the expert group is large number of errors in the vertical movement condition, compared to other conditions, and compared to the other two groups of subjects. One possible explanation for this anomaly is that this group may have had difficulty making precise contact with the pegs in a condition where they were relying purely on their depth perception for guidance, without any visual cues in the horizontal direction. This indicates that even experienced surgeons may find it difficult to maneuver laparoscopic tools to specific locations in a dynamic environment, without making errors. This lack of precision could lead to unintended contact between the surgical tools and delicate surrounding tissues, resulting in potential injuries. Given the short movement time, it is also possible that this represented a speed-accuracy trade-off in the surgeons' performance. (see, FIG. 30)

In one embodiment, the DynaMITE training device challenges even the most highly trained subjects (i.e., for example, expert surgeons), suggesting that there is potential for it to supplement the current training repertoire of motor skills. Practice in dynamic environments can help to improve efficiency of tool motion in environments that are unpredictable and difficult to navigate. In addition, practice in making contact with specific targets inside a dynamic environment can only help to develop precise tool motion, leading to reduced errors and decreased damage of surrounding tissue.

### EXPERIMENTAL

### Example 1

### Training Device Prototype

This example describes one unsuccessful attempt to fabricate a DynaMITE training device.

This training device design consisted of a two dimensional linear stage with a cam driven z axis. At first no height constraints were considered and the overall dimensions for the training device was 14 inches (length) by 14 inches (width).

An iterative process lead to the decision that the most effective way to get the x-y motion was to mount one linear stage atop a second one at a 90 degree angle. They would have been driven with powerscrews and motors attached to the ends. A desired travel of 12 inches was resulted in the complete linear stage (along with the motor hanging off the end) to be about 24 inches long. This exceeded the measurements of the enclosure box. Consequently, a second iteration in design incorporated a smaller range in motion. Not only did the smaller travel decrease the overall size of the apparatus, it also simplified viewing the linear stage on a monitor and there would be a distinct range that the linear stage could actually cover.

Regarding the z motion, a cam driven platform was considered because of simplicity and effectiveness. The design called for a platform to be mounted on four columns that would not only stabilize the platform but would act as guiderails for the platform to slide up and down on. Since height was not considered a constraint, the additional space needed under the platform for the cam and motor was not an issue. The cam would be made out of a metal material such as aluminum and would cause a displacement of one inch vertically.

This design ultimately failed because it was too bulky, heavy and most importantly due to incompatibility with commercially available surgical simulators.

### Example 2

### DynaMITE Training Device

This example describes the overall design strategy to produce one embodiment of the present invention.

The training device specifications were compatible with a ProMIS® surgical simulator, a commercially available surgical simulator that is capable of tracking tool movement. This meant that height was the most important constraint on the final product. In order for enough room to be left in the simulator for tool manipulation, the central platform could only be approximately 3 inches from the simulator at its highest point. Due to the drastic size decrease, the training device according to Example I was deemed incompatible. Further, consultation with outside vendors confirmed that a two dimensional linear stage having the desired travel and a height requirements were unavailable. Consequently, after several design iterations the DynaMITE training device was conceived and reduced to practice. In the present example, the basic mechanics of this training device comprise two cantilever rods controlled by two separate moving platforms to push and pull a central platform attached to a scissor lift to provide vertical movement to a target array.

### Example III

### User Guide for a DynaMITE Training Device

This example provides illustrative step-by-step procedures for the use of one embodiment of a training device contemplated by the present invention.

### Installation

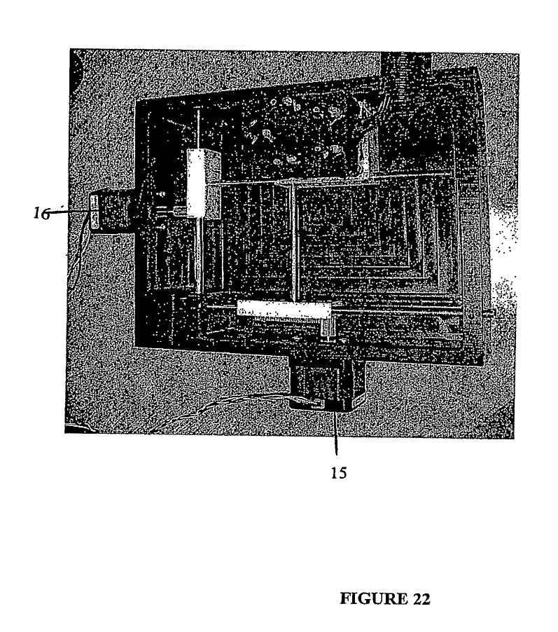

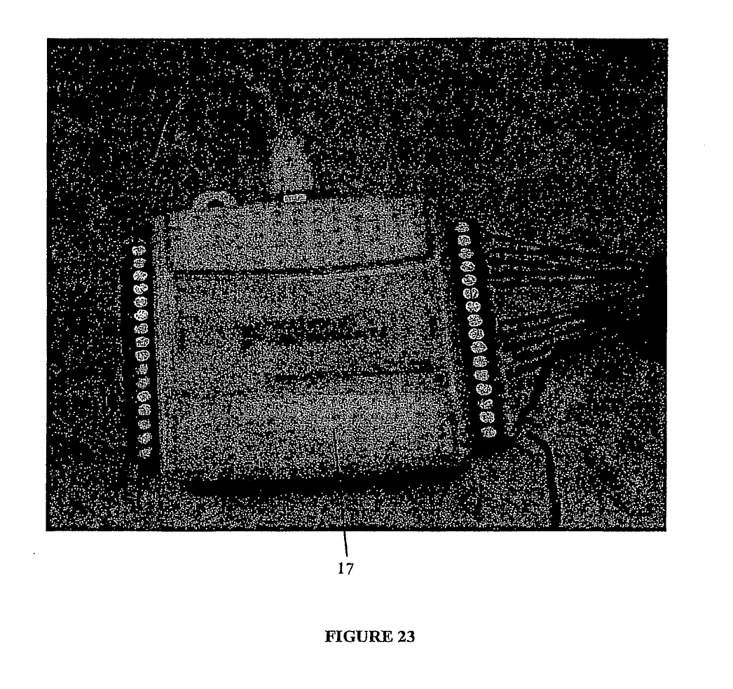

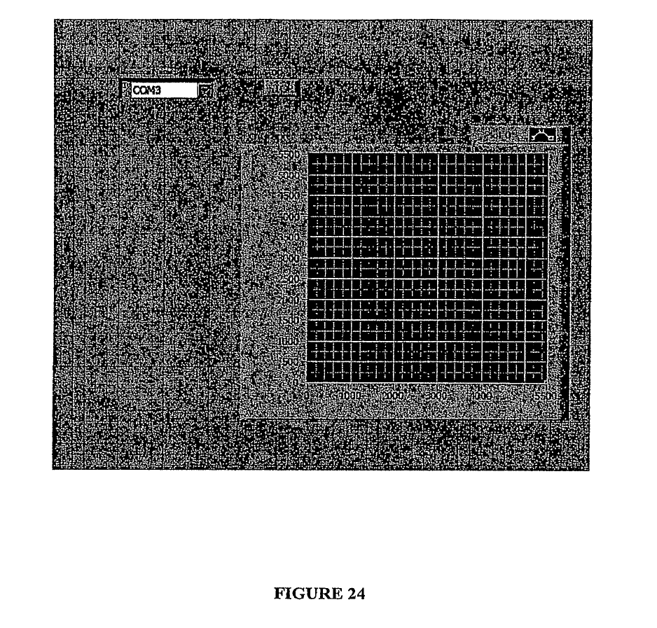

1. Install MAX® (National Instrument's Measurement & Automation Explorer) software on an IBM-compatible PC.
2. Place a DynaMITE training device inside the ProMIS® surgical simulator and align it so that a first motor 15 is on the bottom and a second motor 16 is on the left side if the user were to be looking down at it from a birds-eye view. See, FIG. 22.
3. Plug in a NI-6008 DAQ control board 17 into a USB port on the computer. See, FIG. 23. Under the Devices menu in the Hierarchy tree, it should appear as Dev1 or Dev2. The device will be named as NI-6008. A small blinking green light on the DAQ board will indicate that the board is on and receiving power from the computer.
4. Plug the female serial end of the Serial-to-USB converter cable into the BiStepA06 Parallax Motor Control Board. Plug the control board into a wall outlet (the green LED on the control board should light up to indicate the board is powered on) and the male USB end of the converter cable into another USB port on the computer. Under the “Devices” hierarchy in MAX®, the USB port configuration should appear under the subtree “ports and interfaces.” It will appear as a COM port. Take note of the number.
5. Open LabVIEW® 7.1. Then open a “motor path subVI” routine of choice (i.e., for example, Diag1, Diag2, or Hourglass1). On the front panel, set the COM port to the port the Parallax board is connected to. See, FIG. 24.
6. Open the LED test program. Now the test is ready to be run.

### To Run a Test

1. Open a “motor path VI” routine of choice. Run the “motor path subVI” routine by clicking on the “run arrow”. The central platform should now be moving along its programmed path.
2. Open the Test program. Run the VI by clicking the run arrow. The user will be prompted by a dialog box requesting the time per task, and the order in which to contact the targets. The value to time is in seconds. The targets are numbered 1, 2, 3, 4, and 5. Choosing a time that is either zero seconds or not an integer will result in an error message and require the user to re-enter all of the inputs. The same result will occur if a target other than 1, 2, 3, 4, or 5 is chosen as a target.
3. As soon as the user clicks OK, the first task will start. The results will be displayed when all five tasks have been completed. After viewing detailed results, the user will then be prompted with another dialog box asking if the user is finished. By clicking “OK”, the “motor path subVI” routine resets to default values, thereby erasing the current results so that another test may be run.
4. After all five tasks are finished, switch back to the motor path VI and click the STOP button located on the front panel. See, FIG. 24. This will end the motor path VI and send the stage back to its “home” position. DO NOT STOP THIS “MOTOR PATH subVI” ROUTINE BY CLICKING THE STOP SIGN! If the “Stop Sign” is selected, the “motor path subVI” routine will simply end and the central platform will not return to its “home” position.

### Example IV

### Troubleshooting a DynaMITE Training Device

This example provides illustrative step-by-step procedures to diagnose problems using one embodiment of a training device contemplated by the present invention.
1. If the stage does not move, or if the motor path VI presents the user with an error message, check to make sure the COM port selected in the motor path VI is the actual COM port the motor control board is plugged into. If not, check under the Devices menu in MAX to identify the COM port the board is using. If everything is set correctly but the error still persists, unplug both boards from their USB ports, close LabVIEW, plug both USB cables back in, and re-open LabVIEW®.
2. If the LED program does not seem to work or presents the user with an error, check to make sure that the NI-6008 DAQ board is labeled as Dev1 in MAX. If the board is not labeled Dev1, the user must do a little reprogramming. The board should be labeled as DevX, where X is a number. If X=2, then the board is labeled as Dev2. In the front panel of the LED program, at the top of the screen click Windows-Show Block Diagram. In the block diagram there should be an icon of a snowman. Double click on the snowman, and then in the snowman's front panel again select Windows-Show Block Diagram. There will be a LabVIEW® constant with the text Dev1 in it. Simply retype Dev2 (if MAX labeled the board as Dev2, otherwise type the label MAX gave the board). Save the change and close the snowman subVI. Then, in the block diagram of the LED program, double click on the icon of the alien. Make sure that wherever a constant is labeled Dev1 it is changed to reflect the new label (Dev2, or whatever other label MAX uses). Perform a save of the alien sub VI and close that.
3. Another possible place for error is the configuration of the board. In MAX, under the Dev1 (or whatever other label MAX uses to identify the NI-6008 DAQ board), double click on it and select the Test Panel. Choose Digital I/O and make sure that ports 0.7, 1.0-1.3 are selected as output channels. Then close MAX.
4. If the “motor path subVI” routine was stopped with the “Stop Sign” instead of the STOP button, the stage must be reset manually to its “home position.” Simply manually move the stage to the upper-left hand corner of the training device, ensuring that the gearheads of both motors are still engaging their respective racks. Failure to do this could cause damage to the motors or gears the next time a “motor path subVI” routine is run. Correct orientation of the stage can be seen in FIG. 22.

### Example V

### Subject Training Tasks Using a DynaMITE Surgical Simulator

This example provides data showing the utility of training subjects with differing amounts of laparoscopic experience by performing simple aim-and-point tasks.

### Methods

### 1) Subjects

Fifteen subjects (5 naïve subjects, 5 PGY2 surgical residents, and 5 surgical attendings) participated in the study. Subjects included both right-handed and ambidextrous people, ranging in age from 20 to 62. Six males and nine females were tested.

### 2) Apparatus Design

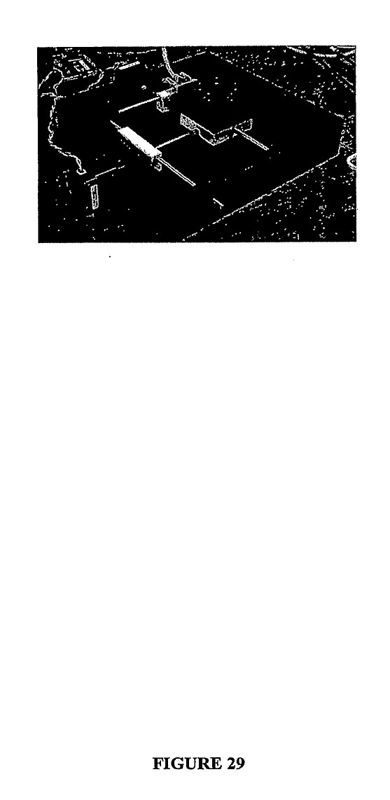

A dynamic minimally invasive surgical training environment (DynaMITE) consisted of a 9″×9″×3″ base, fitted with a target array (see FIG. 29), that has controlled motion in two directions. The dimensions of the base were chosen to fit the DynaMITE device within existing standard-sized laparoscopic simulators, such as the ProMIS™ (Haptica, Inc) or any other physical trainer box. The target array's overall dimensions were 2.5″×2.5″×1″, with five vertical metal pegs, each surrounded by a light fixture. The movement of the target array in orthogonal directions, and its speed, were controlled by motors.

A control interface was developed to allow the motion of the target and the illumination of the lights to be controlled through a computer interface. This interface was used to control the following features of the apparatus: shape of target trajectory, speed of target motion, time limit for task completion, and order in which pegs should be touched.

Incorporated into the computer system was an automatic scoring mechanism which detected successful contact with illuminated pegs, undesired contact with non-illuminated pegs, time taken to successfully touch each peg, the frequency with which a subject exceeded the time limit before making contact with the target peg, and target location at time of contact with a peg.

### 3) Task and Experimental Design

Subjects were presented with a target array in five different movement and trajectory conditions: 1) static, 2) horizontal, 3) vertical, 4) slow hourglass-shaped, and 5) fast hourglass-shaped. The subjects used a laparoscopic tool to touch the top of one of the five metal pegs, according to which indicator light was turned on. When successful contact was made with the illuminated peg, a different peg was illuminated. This pattern continued until successful contacts were made with all five pegs, or until a specified allowable task time had elapsed. The order of the pegs to be touched was randomized. Subjects were presented with one trial of all five target conditions in order, beginning with static and ending with the fast hourglass condition. This series was repeated 3 times, for a total of three trials per subject in each target condition.

### 4) Dependent Measures

The dependent variables in the experiment were number of successful hits, number of misses (defined as inability to make contact with a peg in the specified time limit), number of errors (defined as contact with a non-illuminated peg), time to task completion, and spatial location of target at time of hit. Since the experiment was conducted with the DynaMITE apparatus fitted inside of a ProMIS simulator, the additional dependent variables of tool path length and tool path smoothness were included in the data collection. Path length values represent the total length of the tool trajectory, measured in millimeters. Smoothness values indicate the degree of jerk in movements, where smaller values represent smoother tool motion.

### 5) Data Analysis

Data were analyzed using analysis of variance (ANOVA) and post-hoc Tukey tests.

### Results

### 1) Static Task

In the static condition, there was a statistically significant difference in time to task completion (p<0.001), number of misses (p=0.04), path length (p=0.04), and path smoothness amongst the different subject groups (p=0.016) (see Table II).

TABLE II
Summary of results for static target condition

| | Task Completion Time | | | Path Length | Smoothness |
|---|---|---|---|---|---|
| | (sec ± SD) | Total Misses | Total Errors | (mm ± SD) | (s³/m ± SD) |
| Novice | 5.71 ± 3.55* | 3 | 4 | 3668.67 ± 1580 | 253.9 ± 113.7* |
| PGY2 | 3.90 ± 2.2 | 0 | 4 | 2583.33 ± 1013 | 189.6 ± 53.8^{†} |
| Expert | 2.83 ± 1.98* | 0 | 0 | 2712 ± 1146 | 176.6 ± 54.5*^{†} |
| p-value | 0.001 | 0.04 | NS | 0.04 | 0.016 |

*^{†}Indicate significantly different means between groups as determined by a post-hoc Tukey test.
P-values indicate significance levels determined by an ANOVA test. NS = Not Significant.

A post-hoc Tukey test showed that experts were significantly faster than the novices, but not faster than the PGY2s. Experts also had significantly better smoothness results than both PGY2 and novice groups.

### 2) Horizontal Task

There was a statistically significant difference in time to task completion (p<0.001), path length (p=0.002) and path smoothness (p<0.001) amongst the three subject groups (see Table III).

TABLE III
Summary of results for horizontal target trajectory condition

| | Task Completion Time | | | Path Length | Smoothness |
|---|---|---|---|---|---|
| | (sec ± SD) | Total Misses | Total Errors | (mm ± SD) | (s³/m ± SD) |
| Novice | 5.56 ± 3.37^{†} | 4 | 8 | 3466.67 ± 925.7* | 246.13 ± 71.9^{†} |
| PGY2 | 3.40 ± 1.81* | 0 | 10 | 2227.33 ± 994.8*^{†} | 146.9 ± 44.1* |
| Expert | 2.54 ± 1.81*^{†} | 0 | 3 | 2477.33 ± 1004^{†} | 135.65 ± 29.2*^{†} |
| p-value | 0.001 | NS | NS | 0.002 | 0.001 |

*^{†}Indicate significantly different means between groups as determined by a post-hoc Tukey test.
P-values indicate significance levels determined by an ANOVA test. NS = Not Significant.

A post-hoc Tukey test showed that PGY2s were better than novices in time, path length, and smoothness, but not in number of misses; experts were better than PGY2s only in the path length measure, and better than novices only in the smoothness and time measures.

### 3) Vertical Task

There was a statistically significant difference in time to task completion (p<0.001), number of misses (p=0.04) and tool smoothness (p=0.005) amongst the three subject groups (see Table VI).

TABLE VI
Summary of data for vertical target trajectory condition

| | Task Completion Time | | | Path Length | Smoothness |
|---|---|---|---|---|---|
| | (sec ± SD) | Total Misses | Total Errors | (mm ± SD) | (s³/m ± SD) |
| Novice | 4.84 ± 3.13 | 1 | 4 | 3464.67 ± 1676 | 219.4 ± 71.18* |
| PGY2 | 3.29 ± 2.56 | 0 | 5 | 2537.33 ± 1693 | 150.7 ± 64.92^{†} |
| Expert | 2.90 ± 2.1 | 0 | 12 | 2554.67 ± 1676 | 150.9 ± 46.87*^{†} |
| p-value | 0.001 | 0.04 | NS | NS | 0.005 |

*^{†}Indicate significantly different means between groups as determined by a post-hoc Tukey test.
P-values indicate significance levels determined by an ANOVA test. NS = Not Significant.

A post-hoc Tukey test showed that experts and PGY2s were better than novices in tool smoothness only.

### 4) Slow Hourglass Task

There was a statistically significant difference in time to task completion (p<0.001), number of misses (p=0.005), path length (p=0.03) and tool smoothness (p<0.001) amongst the three subject groups (see Table V).

TABLE V
Summary of data for slow hourglass target trajectory condition

| | Task Completion Time | | | Path Length | Smoothness |
|---|---|---|---|---|---|
| | (sec ± SD) | Total Misses | Total Errors | (mm ± SD) | (s³/m ± SD) |
| Novice | 5.52 ± 3.97* | 6* | 8 | 3657.78 ± 1470 | 226.47 ± 66.5* |
| PGY2 | 3.45 ± 2.5^{†} | 0^{†} | 9 | 2404 ± 1004 | 155.3 ± 45.55^{†} |
| Expert | 2.69 ± 1.81*^{†} | 0*^{†} | 2 | 2808 ± 1444 | 137.29 ± 46.8*^{†} |
| p-value | 0.001 | 0.005 | NS | 0.03 | 0.001 |

*^{†}Indicate significantly different means between groups as determined by a post-hoc Tukey test.
P-values indicate significance levels determined by an ANOVA test. NS = Not Significant.

A post-hoc Tukey test showed that experts were faster and more smooth in movement, with significantly fewer misses than novices, while PGY2s were more efficient and smooth in movement with significantly fewer misses than novices.

### 5) Fast Hourglass Task

There was a statistically significant difference in time to task completion (p=0.001) and number of misses (p=0.006) amongst the three subject groups (see Table VI).

TABLE VI
Summary of data for fast hourglass target trajectory condition

| | Task Completion Time | | | Path Length | Smoothness |
|---|---|---|---|---|---|
| | (sec ± SD) | Total Misses | Total Errors | (mm ± SD) | (s³/m ± SD) |
| Novice | 6.45 ± 4.29 | 10* | 4 | 4244.73 ± 2137.9 | 248.1 ± 95 |
| PGY2 | 4.93 ± 4.13 | 4 | 14 | 3514.67 ± 1537 | 218.9 ± 71.5 |
| Expert | 4.26 ± 2.5 | 0* | 6 | 3473.33 ± 980 | 193.3 ± 52.1 |
| p-value | 0.001 | 0.006 | NS | NS | NS |

*Indicates significantly different means between groups as determined by a post-hoc Tukey test.
P-values indicate significance levels determined by an ANOVA test. NS = Not Significant.

Post-hoc Tukey tests showed that experts had significantly fewer misses than novices.

### 6) Experience

Two factor ANOVA tests did not reveal any significant interactions between experience and path type. However, one-way ANOVA tests, examining the effect of path shape on performance within each experience group, showed that path shape had a significant main effect on time and smoothness values for PGY2s and experts, but not for novices.

A post-hoc Tukey test revealed a significant difference in time values between the slow and fast hourglass cases for the expert group. There was also a significant difference in smoothness values between the fast hourglass condition and all other path shapes, including the static condition. However, the horizontal, vertical and slow hourglass were not different from one another in the smoothness measure. For PGY2s, there was a significant difference in smoothness values when the horizontal, vertical, and slow hourglass conditions were compared with the fast hourglass condition.

1-13. (canceled)

14. A surgical training simulator, comprising:
a) an apparatus comprising:
i) a housing having at least one aperture;
ii) at least one training instrument, wherein said instrument is inserted through said aperture;
iii) a platform within said housing configured for contact by said instrument;
iv) a driving system comprising at least one motor linked to said platform, wherein said system moves said platform; and
b) a computer program comprising a feedback system for receiving location information from said motor, wherein said motor location data controls said driving system.

15. The method of claim 14, further comprising a camera for capturing images of said instrument in contact with said platform within said housing while said platform is moving.

16. The simulator of claim 14, wherein said housing simulates a human torso.

17. The simulator of claim 14, wherein said training instrument further comprises an electrical end effector.

18. The simulator of claim 14, wherein said training instrument operates by a reversal of control.

19. The simulator of claim 14, wherein said driving system moves said central platform in a direction selected from the group consisting of x, y, and z.

20. A surgical training simulator, comprising:
a) an apparatus comprising:
i) at least one training instrument comprising an end effector electrical contact; and
ii) a platform comprising a target light array configured for contact by said end effector;
iii) a driving system linked to said platform, wherein said system moves said platform; and
b) a computer program comprising a data acquisition system for scoring said end effector in contact with said array.

21. The method of claim 20, further comprising a camera for capturing images of said end effector in contact with said array on said platform while said platform is moving.

22. The simulator of claim 20, wherein said array comprises a plurality of targets.

23. The simulator of claim 20, wherein said targets are electrically connected to said data acquisition system.

24. The simulator of claim 20, wherein said target light array comprises at least one illuminated target.

25. The simulator of claim 24, wherein said end effector contact with said illuminated target generates a signal whereby said illuminated target is turned off.

26. The simulator of claim 25, wherein said signal further provides status information to said data acquisition system.

27. The simulator of claim 20, wherein said training instrument operates by a reversal of control.

28. The simulator of claim 20, wherein said driving system moves said central platform in a direction selected from the group consisting of x, y, and z.

29. A surgical training simulator, comprising:
a) an apparatus comprising:
i) at least one training instrument comprising an end effector electrical contact;
ii) a platform comprising a target light array configured for contact by said end effector;
iii) a driving system comprising at least one motor linked to said platform, wherein said system moves said platform; and
b) a computer program comprising a data feedback system for receiving location information from said motor, wherein said motor location information controls said driving system.

30. The simulator of claim 29, further comprising a camera for capturing images of said end effector in contact with said array on said platform while said platform is moving.

31. The simulator of claim 29, wherein said array comprises a plurality of targets.

32. The simulator of claim 31, wherein said targets are electrically connected to said data acquisition system.

33. The simulator of claim 29, wherein said target light array comprises at least one illuminated target.

34. The simulator of claim 33, wherein said end effector contact with said illuminated target generates a signal whereby a second target is illuminated.

35. The simulator of claim 34, wherein said signal further provides status information to said data acquisition system to control said driving system.

36. The simulator of claim 29, wherein said training instrument operates by a reversal of control.

37. The simulator of claim 29, wherein said driving system moves said platform in a direction selected from the group consisting of x, y, and z.

38-49. (canceled)
